(19) United States
(12) Patent Application Publication
(10) Pub. No.: US 2002/0006590 A1
(43) Pub. Date: Jan. 17, 2002

(54) METHOD OF MANUFACTURING SILVER HALIDE PHOTOGRAPHIC EMULSION, SILVER HALIDE PHOTOGRAPHIC EMULSION USING THE METHOD, AND SILVER HALIDE PHOTOSENSITIVE MATERIAL CONTAINING THE EMULSION

(75) Inventor: RYOJI NISHIMURA, KANAGAWA (JP)

Correspondence Address: BIRCH STEWART KOLASCH & BIRCH, PO BOX 747, FALLS CHURCH, VA, 22040-0747, US

(73) Assignee: Ryoji Nishimura

(21) Appl. No.: 09/095,076

(22) Filed: Jun. 10, 1998

(30) Foreign Application Priority Data
Jun. 19, 1997 (JP) 9-177818

(51) Int. Cl. G03C 1/005

(52) U.S. Cl. 430/567; 430/569

(57) ABSTRACT

A method of manufacturing a silver halide photographic emulsion, comprising a process of forming silver halide tabular grains in which 50% or more of a projected area of the total silver halide being accounted for by tabular grains having an aspect ratio of 3 or more and a equivalent-circle diameter of 1.4 μm or more, said process comprising a host tabular grain formation step (step a), a step of adding an emulsion which contains slightly soluble silver halide grains (step b), and an outermost shell formation step (step c), a silver amount (C_{Ag}) consumed in the (step a) and a silver amount (S_{Ag}) consumed in the (step b) and the (step c) being defined by equation (I) below

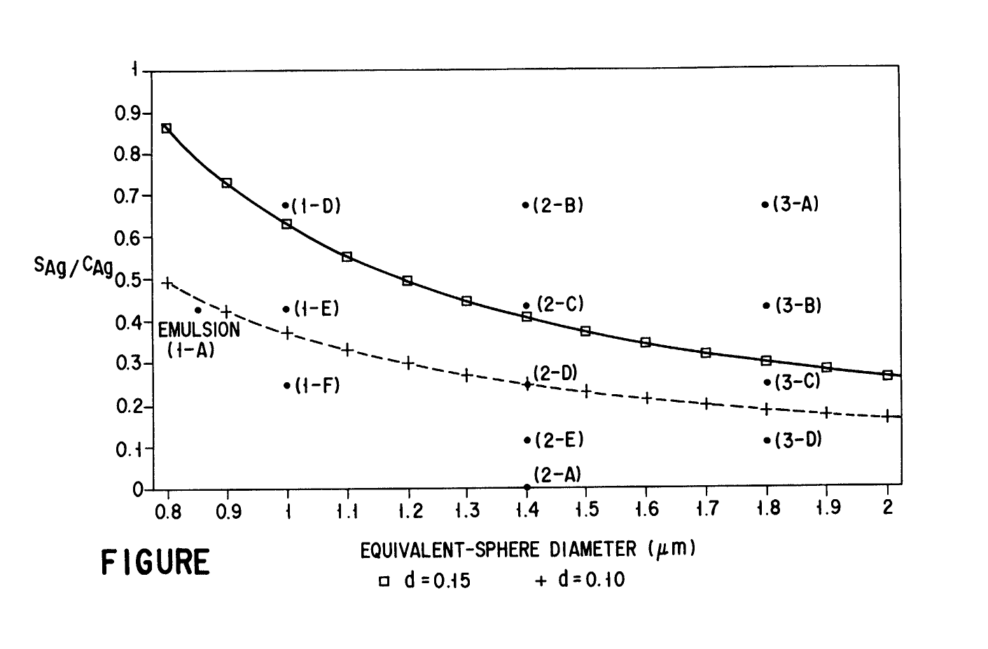

S_{Ag}/C_{Ag}=[R³/(R−d)³]−1 (I)

where d satisfies 0<d≦0.15 and R represents the equivalent-sphere diameter of a final grain.

### BACKGROUND OF THE INVENTION

The present invention relates to a method of manufacturing a silver halide photographic emulsion, an emulsion manufactured by the method, and a silver halide photosensitive material using the emulsion.

More specifically, the present invention relates to a method of manufacturing a silver halide grain emulsion that has high sensitivity and does not largely change its photographic properties due to stress, and an emulsion and a photosensitive material manufactured by the method.

In recent silver halide photosensitive materials, more particularly, photographing sensitive materials such as high speed photosensitive materials for common amateurs represented by an ISO 800 film, it has been increasingly required to have not only high sensitivity and high image quality but also toughness represented by resistance against external pressures.

Generally, a photosensitive material coated with silver halide emulsions experiences various mechanical stresses. For example, a photographic negative film for general purposes is wound into a magazine, bent when loaded into a camera, or pulled upon winding up of a frame. In addition, an exposed negative film must be passed through processing steps for development, during which processing steps, a swelled emulsion surface is sometimes pressed depending on the type of processing machine.

When various stresses are applied to a photosensitive material as described above, silver halide grains contained therein are stressed via gelatin as a holder (binder) of the silver halide grains or via a plastic film as a support. It has been known that the photographic properties of a photosensitive material change when stress is applied to silver halide grains, as reported in detail in, e.g., K. B. Mother, J. Opt. Soc. Am, 38. (1948) 1054, P. Faelens and P. de Smet, Sci. et Ind. Phot., 25. No 5, (1954) 178, P. Faelens, J. Phot. Sci, 2, (1945) 103.

Especially in ultra-high speed photographing sensitive materials, e.g., ISO 800 and 1600 films, tabular grains having a relatively large size, i.e., having an equivalent-sphere diameter exceeding 1 μm are sometimes used to increase the sensitivity.

In this large size region, it becomes very difficult to give pressure resistance to tabular grains as the size increases. This has been a serious problem worrying those skilled in the art.

In this field of art, U.S. Pat. Nos. 4,433,048 and 4,434,226 have already disclosed techniques for manufacturing and using the tabular silver halide grains. It is known that the tabular grains have advantages that the shape of tabular grains improves the sensitivity/graininess relationship and the unique optical properties of tabular grains improve the sharpness, covering power, and the like. This has contributed to the recent rapid progress of silver halide photosensitive materials.

On the other hand, due to the unique shape, this “tabular grain” tends to largely deteriorate in its performance with respect to a photographic property change (such as pressure resistance) caused by stress. In order to reduce this deterioration, various means have been researched.

For example, U.S. Pat. No. 4,806,461 and Jpn. Pat. Appln. KOKAI Publication Nos. 63-220238 and 3-189642 have disclosed techniques of introducing dislocations into tabular silver halide grains under control, thereby improving the sensitivity/graininess relationship, dependence on intensity of exposure illumination, pressure resistance, and storage stability.

On the other hand, U.S. Pat. No. 4,414,310 has disclosed a technique which improves the sensitivity/graininess ratio by forming tabular silver iodobromide which has iodide unevenly dispersed in a grain. However, the technique disclosed in the patent has an unsatisfactory effect in the region of so-called large-size tabular grains having an equivalent-sphere diameter of 1 μm or more.

In addition, Jpn. Pat. Appln. KOKAI Publication No. 5-346631 has disclosed a technique which improves the pressure marks and pressure desensitization by defining the introducing positions of dislocation lines. However, the technique disclosed in the patent does not refer to the resistance against external pressures in a swelled state in processing steps, and the effect of the technique is also very unsatisfactory.

Jpn. Pat. Appln. KOKAI Publication Nos. 3-136032 and 3-136033 and U.S. Pat. No. 5,061,616 have disclosed techniques which improves the pressure desensitization. In the techniques, iodide is added to a tabular host emulsion to form a thin shell of silver iodobromide, and then, the pAg and temperature are defined, resulting in the improvement of the pressure desensitization. Unfortunately, the effect of the improvement is still unsatisfactory.

Recently, however, requirements to these tabular silver halide grains are becoming more and more severe. In particular, the development of an ultra-high speed emulsion which improves deterioration of the photographic properties caused by various stresses is being desired.

### BRIEF SUMMARY OF THE INVENTION

It is an object of the present invention to provide a method of manufacturing a silver halide emulsion which has high sensitivity and does not largely change its photographic properties due to stress.

It is another object of the present invention to provide a silver halide emulsion which is manufactured by the method and a silver halide photosensitive material using the silver halide emulsion.

As a result of extensive studies, we found that the objects of the present invention could be achieved by the following inventions.

(1) A method of manufacturing a silver halide photographic emulsion in which 50% or more of a projected area of a total silver halide are accounted for by tabular grains having an aspect ratio of 3 or more and a equivalent-circle diameter of 1.4 μm or more; the method comprising a step of forming the tabular grains: wherein

the step of forming the tabular grains essentially comprises a host tabular grain formation step (step a), a step of adding an emulsion which contains slightly soluble silver halide grains (step b), and an outermost shell formation step (step c); and

a silver amount (C_{Ag}) consumed in the (step a) and a silver amount (S_{Ag}) consumed in the (step b) and the (step c) are defined by equation (I) below

S_{Ag}/C_{Ag}=[R³/(R−d)³]−1 (I)

where d satisfies 0<d≦0.15 and R represents the equivalent-sphere diameter of a final grain.

(2) A method of manufacturing a silver halide photographic emulsion described in (1), wherein d in equation (I) is 0<d≦0.10.

(3) A method of manufacturing a silver halide photographic emulsion described in (1) or (2), wherein a surface silver iodide content of the silver halide grains is 5 mol % or less.

(4) A method of manufacturing a silver halide photographic emulsion described in one of (1) to (3), wherein the silver halide grains have 10 or more dislocation lines per grain.

(5) A silver halide emulsion manufactured by a method described in one of (1) to (4).

(6) A silver halide photosensitive material comprising, on a support, a silver halide photographic emulsion layer containing a silver halide emulsion manufactured by a method described in one of (1) to (4).

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinbefore.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments give below, serve to explain the principles of the invention, and in which the single FIGURE illustrates a graph in which the relationship between the equivalent-sphere diameter (μm) and the S_{Ag}/C_{Ag} of a tabular grain is plotted.

### DETAILED DESCRIPTION OF THE INVENTION

The present invention will be described in detail below.

A silver halide emulsion manufactured by the method of the present invention comprises tabular grains having an aspect ratio of 3 or more. A tabular grain has outer surface which consist of two parallel major faces and side surfaces connecting these major faces. A tabular grain is a grain having one twin plane or two or more parallel twin planes. If ions at all lattice points have a mirror image relationship to each other on the both sides of a (111) plane, this (111) plane is a twin plane. When this tabular grain is viewed in the direction perpendicular to its major face, the major face has a triangular or hexagonal shape which may be rounded, or a circular shape.

The aspect ratio of a tabular grain means the ratio of the diameter to the thickness of a silver halide grain. That is, the aspect ratio is a value obtained by dividing the diameter of each silver halide grain by its thickness. The diameter herein mentioned is the diameter of a circle having an area equal to the projected area of a silver halide grain when the grain is observed with a microscope or an electron microscope. This diameter is called an equivalent-circle diameter. Therefore, when a grain has an aspect ratio of 3 or more, this means that this equivalent-circle diameter is three times or more the thickness of the grain.

An example of a method for measuring an aspect ratio is a method of taking a transmission electron micrograph by a replica method and obtaining the equivalent-circle diameters and thicknesses of individual grains. In this method the thickness is calculated from the length of shadow of the replica.

In the tabular grains used in the present invention, 50% or more of a projected area has an aspect ratio of 3 or more, preferably 5.0 or more, and more preferably 7.0 or more. If the aspect ratio is too large, the variation coefficient of a grain size distribution tends to increase. It is preferable, therefore, that the aspect ratio is usually set to 20 or less.

The ratio accounted for by tabular grains used in the present invention is 50% or more, preferably 80% or more of the total projected area. If the ratio accounted for by tabular grains is less than 50%, the photographic properties significantly deteriorate so that the present invention cannot be accomplished.

The equivalent-circle diameter of grains used in the present invention is 1.4 μm or more, preferably 1.4 to 5.0 μm, and more preferably 2.0 to 5.0 μm.

The thickness of tabular grains used in the present invention is preferably less than about 0.8 μm, more preferably 0.05 to 0.6 μm, and most preferably 0.1 to 0.5 μm.

Tabular grains used in the present invention are preferably monodisperse. Although the structure and the manufacturing method of monodisperse tabular grains of the present invention follows the disclosure in, e.g., Jpn. Pat. Appln. KOKAI Publication No. 63-151618, the shape of the grains will be briefly described below. That is, 70% or more of the total projected area of silver halide grains are accounted for by tabular grains having a hexagonal shape and two parallel surfaces as outer surfaces, in which the ratio of an edge having the maximum length with respect to the length of an edge having the minimum length is 2 or less. In addition, the grains have monodispersibility; that is, the variation coefficient of a grain size distribution of these hexagonal tabular grains (i.e., a value obtained by dividing a variation (standard deviation) in grain sizes, which are represented by equivalent-circle diameters of projected areas of the grains, by their average grain size) is 20% or less. The variation coefficient of a grain size distribution is preferably 18% or less.

Tabular grains of the present invention are essentially prepared by three steps, i.e., a host tabular grain formation step (step a), a step of adding an emulsion which contains slightly soluble silver halide grains (step b), and an outermost shell formation step (step c). The term “Essentially” used herein means that the emulsion preparation steps indispensably comprise at least these three steps (a to c). Details of each step will be described below.

The host tabular grain formation (step a) of the present invention includes at least a nucleation step, a ripening step, and a growth step. The step itself is well known and described in detail in, e.g., U.S. Pat. No. 4945037. The ripening step and the growth step can be repeated in arbitrary order. The growth step is commonly a step of adding an aqueous silver salt solution and an aqueous halide solution into a mixer by using the double-jet method. The mixer is preferably a mixer capable of adding each aqueous solution by means of forced feed into liquid, examples of which are described in U.S. Pat. No. 3,785,777 and West German Patent No. 2556888.

As one form of the double-jet method, it is possible to use a so-called controlled double-jet method which holds the pAg constant in a liquid phase generating a silver halide. This method is preferable because a silver halide emulsion having a regular crystal shape and a nearly uniform grain size can be obtained.

Host tabular grains used in the present invention are tabular silver halide grains having one twin plane or two or more twin planes which is parallel each other.

Host tabular grains used in the present invention are preferably silver bromide, silver iodobromide, silver chlorobromide, or silver bromochloroiodide, and more preferably silver bromide or silver iodobromide containing 10 mol % or less of silver iodide.

Host tabular grains used in the present invention can have at least two structures having essentially different halogen compositions in a grain, or may have a uniform halogen composition throughout the grain. Preferably, host tabular grains have two or more structures of different halogen compositions. The boundary of halogen compositions between the structures can be a definite one, or the halogen composition between the structures can be continuously changed.

When host tabular grains having two or more structures of different halogen composition are used, the halogen composition of the outermost shell of the host tabular grain preferably does not essentially contain silver iodide, and is more preferably silver bromide. The phrase “Does not essentially contain silver iodide” used herein means that regardless of the internal iodide structure of a host grain, no silver iodide is detected when the silver iodide content of the surface of the host grain is measured by using an XPS method (to be described later).

In host tabular grains used in the present invention, 60% or more of the projected area of the total silver halide host grains are accounted for by tabular grains having an aspect ratio of 3.0 or more, preferably 5.0 or more, and more preferably 7.0 or more. If the aspect ratio is too large, the variation coefficient of a grain size distribution tends to increase. Commonly, therefore, the aspect ratio is preferably 20 or less.

When host tabular grains used in the present invention are silver iodobromide, the variation coefficient of a grain size distribution is preferably 25% or less, and more preferably 20% or less.

The diameter of the host tabular grains is preferably about 0.2 to 4.0 μm, more preferably 0.3 to 3.0 μm, and most preferably 0.4 to 3.0 μm. The thickness of the host tabular grains is preferably less than about 0.5 μm, more preferably 0.05 to 0.5 μm, and most preferably 0.08 to 0.4 μm.

Host tabular grains used in the present invention can be subjected to reduction sensitization. This reduction sensitization is done by a conventional method well known to those skilled in the art, e.g., the addition of a reducing agent or the like or reduction at high pH. The reduction sensitization methods will be described in detail later.

Host emulsion grains used in the present invention can be added as a seed emulsion previously prepared through steps of grain formation, washing, and precipitation or can be prepared by growing the seed emulsion. That is, the seed emulsion can be used as host grains, or grains prepared by growing the seed emulsion can be used as host grains.

Details of said step b will be described below.

In the present invention, step b, i.e., the step of adding a slightly soluble silver halide emulsion to the host tabular grains formed in the step a is performed.

“A slightly soluble silver halide emulsion” used herein means an emulsion whose halogen composition is more hardly soluble than host tabular grains, and is preferably an emulsion containing fine silver iodide grains.

It is only required for the emulsion containing fine silver iodide grains to be essentially silver iodide. “be essentially silver iodide” used herein means that the emulsion can contain silver bromide and/or silver chloride as long as mixed crystal is formed. Preferably, the emulsion is 100% silver iodide. The crystal structure of silver iodide can be a β type, a γ type, and, as described in U.S. Pat. No. 4,672,026, an α type or an α analogue type. Although this crystal structure is not particularly limited in the present invention, the crystal structure is preferably a mixture of the β and γ types, and more preferably the β type.

The emulsion containing fine silver iodide grains can be easily formed by a method described in, e.g., U.S. Pat. No. 4,672,026 described above. A double-jet addition method of adding an aqueous silver salt solution and an aqueous iodide salt solution, by which grain formation is performed by holding the pI value constant, is preferable. The pI is the logarithm of the reciprocal of the I-ion concentration in the system.

The temperature, pI, pH, and presence/absence of a silver halide solvent are not particularly limited. However, the temperature, pI value, and pH value are preferably 35° C. to 50° C., 2.5 to 5.0, and 3.0 to 8.0, respectively. For the sake of convenience in the present invention, the equivalent-circle diameter of grains is set to 0.1 μm or less, preferably 0.07 μm or less. Although the grain shape cannot be completely specified because the grains are fine, the variation coefficient of a grain size distribution is preferably 25% or less, and more preferably 20% or less. The size and size distribution of an emulsion containing fine silver iodide grains are measured by placing the fine grains on a mesh for electron microscopic observation and observing the grains by a direct transmission method, rather than a carbon replica method. The reason for this is that because the grain size is small, the measurement error increases if the observation is done by the carbon replica method.

The most effective slightly soluble silver halide emulsion of the present invention consists of fine silver iodide grains having an equivalent-circle diameter of grains of 0.02 to 0.06 μm and a variation coefficient of an equivalent-circle diameter distribution of 20% or less.

In the present invention, the addition of the slightly soluble silver halide emulsion is performed following the host tabular grain formation step (step a). It is preferable that this addition of the slightly soluble silver halide emulsion is abruptly performed. The term “abrupt addition” used herein means that the slightly soluble silver halide emulsion is added within preferably 10 min, and more preferably 5 min. The addition conditions can change depending on the factors of the system to which the slightly soluble silver halide emulsion is added, including the temperature, the pBr, the pH, the type and concentration of a protective colloid agent such as gelatin, as well as the presence/absence, type, and concentration of a silver halide solvent. In any case, however, the addition is preferably abruptly performed.

Furthermore, in the present invention, the temperature of the system to which the slightly soluble silver halide emulsion is added is preferably 40° C. to 90° C., and particularly preferably 50° C. to 80° C.

Additionally, in the present invention, an optimal value of the pBr of the system to which the slightly soluble silver halide emulsion is added changes in accordance with the temperature of the system. For example, when the temperature of the system is 75° C., the pBr is preferably 0.8 to 2.0.

The slightly soluble silver halide emulsion is usually dissolved before being added to the system, and it is necessary to well increase the stirring efficiency of the system before the addition. The addition of an anti-foaming agent is effective to prevent the generation of foam during stirring. More specifically, an anti-foaming agent described in, e.g., an embodiment of U.S. Pat. No. 5,275,929 is used.

The addition amount of the slightly soluble silver halide emulsion is preferably 1 to 10 mol %, as a silver amount, of host tabular grains. The addition amount is most preferably 3 to 7 mol %.

In the present invention, the step of adding the slightly soluble silver halide emulsion can be performed prior to or simultaneously with the outermost shell formation step (step c), or can be separately performed before and during the (step c). Preferably, the addition step is performed prior to the (step c).

Now, details of the outermost shell formation step (step c) will be described below.

In the tabular grains of the present invention, after or during the abrupt addition of the slightly soluble silver halide emulsion to host tabular grains, the outermost shell is formed by growing silver bromide, silver iodobromide, silver chlorobromide, or silver bromochloroiodide. More preferably, silver bromide is grown to form the outermost shell. Preferably, the formation of the outermost shell is performed after the addition of the slightly soluble silver halide emulsion is complete. The time interval from the addition of the slightly soluble silver halide emulsion to the start of the formation of the outermost shell is preferably 1 sec to 10 min.

Basically, this time interval is preferably shorter, and it is preferable to appropriately set the time interval in accordance with the conditions such as the temperature and pBr of the system.

Although the temperature, pH, and pBr at which the outermost shell is formed are not particularly limited, the temperature and pH are usually 40° C. to 90° C. and 2 to 10, respectively. More preferably, the temperature is 50° C. to 80° C., and the pH is 3 to 7. It is also preferable that the pBr at the time when the formation of the outermost shell is complete be higher than the pBr at the time when the formation started. Preferably, the pBr at the start of the formation of the outermost shell is 2.9 or less, and the pBr at the end of the formation is 1.4 or more. Most preferably, the pBr at the start of the formation of the outermost shell is 2.1 or less, and the pBr at the end of the formation is 1.6 or more.

In the present invention, the ratio of a silver amount (C_{Ag}) consumed in the (step a) to a silver amount (S_{Ag}) consumed in the (step b) and the (step c) is defined by equation (I) below.

S_{Ag}/C_{Ag}=[R³/(R−d)³]−1 (I)

where d satisfies 0<d≦0.15 and R represents the equivalent-sphere diameter of a final grain.

The FIGURE shows the region represented by equation (I). The range of d is preferably 0<d≦0.10.

In the case of a so-called regular crystal cubic or octahedral grain having a core portion and a shell portion, d is a value corresponding to the thickness of a shell when the grain is isotropically grown.

The range of the equivalent-sphere diameter is preferably 0.5 to 5.0 μm, and more preferably 0.8 to 2.0 μm.

In the case of tabular grains of the present invention, the outermost shell is not always isotropically grown in any case. Therefore, it cannot be said that d indicates the thickness itself of the outermost shell. However, d is at least a value relating to the outermost shell thickness.

In order to improve both the photographic properties and the pressure resistance of tabular grains manufactured by using the method of the present invention, it is critically important as described above to define the ratio of the silver amount used in the host tabular grains to the silver amount used in the slightly soluble silver halide emulsion and the formation of the outermost shell with respect to the final grain size. It was totally unexpected finding by the present invention. According to the present invention, it is possible to obtain a tabular emulsion having a sensitivity/graininess ratio and pressure resistance extraordinarily higher than those of conventionally known tabular grains.

Tabular grains manufactured by using the method of the present invention preferably have a halogen composition distribution or structure in a grain. If this is the case, a grain structure for a silver iodide distribution can be any of a double structure, a triple structure, a quadruple structure, a quintuple structure, and a structure of a higher order. In any structure, the surface silver iodide content is preferably 5.0 mol % or less, and more preferably 3.0 mol % or less with respect to a silver halide on the surface. The “surface” means a region within 50 Å from the grain surface, i.e., a region detectable by XPS explained next.

The silver iodide content on the grain surface can be measured by XPS (X-ray Photoelectron Spectroscopy).

The principle of XPS is described in detail in, e.g., Junnich Aihara et al., “Spectra of Electrons” (Kyoritsu Library 16: issued Showa 53 by Kyoritsu Shuppan).

A standard measurement method of XPS is to use Mg-Kα as excitation X-rays and measure the intensities of photoelectrons of iodine (I) and silver (Ag) released from silver halide grains in an appropriate sample form. The content of iodine can be calculated from a calibration curve of the photoelectron intensity ratio (intensity (I)/intensity (Ag)) of iodine (I) to silver (Ag) formed by using several different standard samples having known iodine contents. XPS measurement for a silver halide emulsion must be performed after gelatin adsorbed on the surface of a silver halide grain is decomposed and removed by, e.g., proteinase.

An average silver iodide content can be measured by analyzing the compositions of individual grains by using an X-ray microanalyzer. The “average silver iodide content” is an arithmetic mean obtained by measuring the silver iodide contents of at least 100 emulsion grains. A method of measuring the silver iodide content of each individual grain is described in, e.g., European Patent No. 147868A.

Tabular grains used in the present invention are silver iodobromide containing preferably 10 mol % or less, and more preferably 8 mol % or less of silver iodide.

Silver halide emulsion grains manufactured through the steps (a), (b), and (c) of the present invention sometimes have dislocation lines.

Dislocation lines in tabular grains can be observed by a direct method using a transmission electron microscope at a low temperature described in, for example, J. F. Hamilton, Phot. Sci. Eng., 11, 57, (1967) or T. Shiozawa, J. Soc. Phot. Sci. Japan, 35, 213, (1972).

That is, silver halide grains, extracted carefully from an emulsion so as not to apply a pressure at which dislocations are produced in the grains, are placed on a mesh for electron microscopic observation. Observation is performed by a transmission method while the sample is cooled to prevent damages (e.g., print out) due to electron rays. In this case, as the thickness of a grain is increased, it becomes more difficult to transmit electron rays through it. Therefore, grains can be observed more clearly by using an electron microscope of a high voltage type (200 kV or more for a grain having a thickness of 0.25 μm). From photographs of grains obtained by the above method, it is possible to obtain the positions and the number of dislocations in each grain viewed in the direction perpendicular to the major faces of the grain.

Note that dislocation lines can or cannot be seen depending on the angle of inclination of a sample with respect to electron rays. Therefore, in order to observe dislocation lines without omission, it is necessary to obtain the positions of dislocation lines by observing photographs of the same grain taken at as many sample inclination angles as possible.

In the present invention, the positions and the number of dislocation lines are obtained by taking five photographs of the same grain at inclination angles different by a 5° step by using a high-voltage electron microscope.

Tabular grains of the present invention preferably have 10 or more dislocation lines per grain.

If dislocation lines are densely present or cross each other, it is sometimes impossible to correctly count dislocation lines per grain. Even in these situations, however, dislocation lines can be roughly counted to such an extent as in units of 10 lines, making it possible to distinguish these grains from those in which obviously only a few dislocation lines are present. The average number of dislocation lines per grain is obtained as a number average by counting dislocation lines of 100 or more grains.

Dislocation lines can be introduced to, e.g., a portion near the peripheral region of a tabular grain. In this case, dislocations are substantially perpendicular to the peripheral region and extend from a position which is located at x(%) of the length between the center and the edge (peripheral region) of a tabular grain to the peripheral region. The value of x is preferably 10 to less than 100, more preferably 30 to less than 99, and most preferably 50 to less than 98. In this case, although a shape obtained by connecting the start positions of the dislocations is almost similar to the shape of the grain, it is not perfectly similar but sometimes distorted.

In addition to the above positions, dislocation lines can also be formed over a region including the center of the two major faces. When dislocation lines are formed over the entire area of the major face, the direction of the dislocation lines is crystallographically, approximately a (211) direction when viewed in the direction perpendicular to the major face. However, the dislocation lines are sometimes formed in a (110) direction or at random. The length of each dislocation line is also random; i.e., a dislocation line is sometimes observed as a short line on the major face and is sometimes observed as a long line reaching the edge (peripheral region). Dislocation lines are sometimes straight and often zigzagged. In many instances, dislocation lines cross each other to form network dislocation lines.

A tabular grain can have dislocation lines either almost uniformly over the whole peripheral region or at a particular position of the peripheral region. That is, in the case of a hexagonal tabular silver halide grain, dislocation lines can be limited to either portions near the six corners or only a portion near one of the six corners. Conversely, it is also possible to limit dislocation lines to only portions near the edges except for the portions near the six corners.

It is advantageous to use gelatin as a protective colloid for use in preparation of emulsions of the present invention or as a binder for other hydrophilic colloid layers. However, another hydrophilic colloid can also be used in place of gelatin.

Examples of the hydrophilic colloid are protein, such as a gelatin derivative, a graft polymer of gelatin with another high polymer, albumin, and casein; a cellulose derivative, such as hydroxyethylcellulose, carboxymethylcellulose, and cellulose sulfates; a sugar derivative, such as soda alginate, and starch derivative; and a variety of synthetic hydrophilic high polymers, such as homopolymers or copolymers, e.g., polyvinyl alcohol, polyvinyl alcohol partial acetal, poly-N-vinylpyrrolidone, polyacrylic acid, polymethacrylic acid, polyacrylamide, polyvinylimidazole, and polyvinylpyrazole.

Examples of gelatin include lime-processed gelatin, acid-processed gelatin, and enzyme-processed gelatin described in Bull. Soc. Sci. Photo. Japan. No. 16, P 30 (1966). In addition, a hydrolyzed product or an enzyme-decomposed product of gelatin can also be used.

In the emulsion preparation method of the present invention, it is preferable to perform washing for a desalting purpose after the step (c) followed by dispersing in a newly prepared protective colloid dispersion medium. Although the temperature of washing can be selected in accordance with the intended use, it is preferably 5° C. to 5° C. Although the pH of washing can also be selected in accordance with the intended use, it is preferably 2 to 10, and more preferably 3 to 8. The pAg of washing is preferably 5 to 10, though it can also be selected in accordance with the intended use. The washing method can be selected from noodle washing, dialysis using a semipermeable membrane, centrifugal separation, coagulation precipitation, and ion exchange. The coagulation precipitation can be selected from a method using sulfate, a method using an organic solvent, a method using a water-soluble polymer, and a method using a gelatin derivative.

In the emulsion preparation method of the present invention, it is preferable to make salt of metal ion exist at any timing in accordance with the intended use, for example, between the start of the step a and the end of the step c, during desalting, or chemical sensitization, or before coating. The metal ion salt is preferably added during grain formation when doping for grains is desired, as well as after the end of the step c and before the end of chemical sensitization when modification of the grain surface is desired or when the metal ion salt is used as a chemical sensitizer. The doping can be performed for any of an overall grain, only the core (=host grain), only the shell, and only the epitaxial portion of a grain. Examples of the metal are Mg, Ca, Sr, Ba, Al, Sc, Y, La, Cr, Mn, Fe, Co, Ni, Cu, Zn, Ga, Ru, Rh, Pd, Re, Os, Ir, Pt, Au, Cd, Hg, Tl, In, Sn, Pb, and Bi. These metals can be added as long as they are in the form of salt that can be dissolved during grain formation, such as ammonium salt, acetate, nitrate, sulfate, phosphate, hydroxide salt, 6-coordinated complex salt, or 4-coordinated complex salt. Examples are CdBr₂, CdCl₂, Cd(NO₃)₂, Pb(NO₃)₂, Pb(CH₃COO)₂, K₃{Fe(CN)₆}, (NH₄)₄{Fe(CN)₆}, K₃IrCl₆, (NH₄)₃RhCl₆, and K₄Ru(CN)₆. The coordination complex compound can be selected from halogeno-, aquo-, cyano-, cyanato-, thiocyanato-, nitrosyl-, thionitrosyl-, oxo-, and carbonyl-complex compound. 00These metal compounds can be used either singly or in the form of a combination of two or more types of them. The addition amount is preferably 1×10⁻⁹ to 1×10⁻³ mol/molAg.

The metal compounds are preferably dissolved in an appropriate solvent, such as methanol or acetone, and added in the form of a solution. To stabilize the solution, an aqueous hydrogen halide solution (e.g., HCl and HBr) or an alkali halide solution (e.g., KCl, NaCl, Kbr, and NaBr) can be added. It is also possible to add acid or alkali if necessary. The metal compounds can be added to a reactor vessel either before or during grain formation. Alternatively, the metal compounds can be added to a water-soluble silver salt (e.g., AgNO₃) or an aqueous alkali halide solution (e.g., NaCl, KBr, and KI) and added in the form of a solution continuously during formation of silver halide grains. Furthermore, a solution of the metal compounds can be prepared independently of a water-soluble salt or an alkali halide and added continuously at a proper timing during grain formation. It is also possible to combine several different addition methods.

It is sometimes useful to perform a method of adding a chalcogen compound during preparation of an emulsion, such as described in U.S. Pat. No. 3,772,031. In addition to S, Se, and Te, cyanate, thiocyanate, selenocyanic acid, carbonate, phosphate, and acetate can be present.

In the formation of silver halide grains of the present invention, at least one of chemical sensitization selected from sulfur sensitization, selenium sensitization, and noble metal sensitization such as gold sensitization and palladium sensitization, and reduction sensitization can be performed in any arbitrary step during the process of manufacturing a silver halide emulsion. The use of two or more different sensitizing methods is preferable. Several different types of emulsions can be prepared by changing the step in which the chemical sensitization is performed. The emulsion types are classified into: a type in which a chemical sensitization nucleus is embedded inside a grain, a type in which it is embedded in a shallow position from the surface of a grain, and a type in which it is formed on the surface of a grain. In emulsions of the present invention, the position of a chemical sensitization nucleus can be selected in accordance with the intended use. However, it is generally preferable to form at least one type of a chemical sensitization nucleus on the surface.

One chemical sensitization which can be preferably performed in the present invention is chalcogen sensitization, noble metal sensitization, or a combination of these. The sensitization can be performed by using an active gelation as described in T. H. James, The Theory of the Photographic Process, 4th ed., Macmillan, 1977, pages 67 to 76. The sensitization can also be performed by using any of sulfur, selenium, tellurium, gold, platinum, palladium, and iridium, or by using a combination of a plurality of these sensitizers at pAg 5 to 10, pH 5 to 8, and a temperature of 30 to 80° C., as described in Research Disclosure, Vol. 120, April, 1974, 12008, Research Disclosure, Vol. 34, June, 1975, 13452, U.S. Pat. Nos. 2,642,361, 3,297,446, 3,772,031, 3,857,711, 3,901,714, 4,266,018, and 3,904,415, and British Patent No. 1,315,755. In the noble metal sensitization, salts of noble metals, such as gold, platinum, palladium, and iridium, can be used. In particular, gold sensitization, palladium sensitization, or a combination of the both is preferable. In the gold sensitization, it is possible to use known compounds, such as chloroauric acid, potassium chloroaurate, potassium aurithiocyanate, gold sulfide, and gold selenide. A palladium compound means a divalent or tetravalent salt of palladium. A preferable palladium compound is represented by R₂PdX₆ or R₂PdX₄ wherein R represents a hydrogen atom, an alkali metal atom, or an ammonium group and X represents a halogen atom, i.e., a chlorine, bromine, or iodine atom.

More specifically, the palladium compound is preferably K₂PdCl₄, (NH₄)₂PdCl₆, Na₂PdCl₄, (NH₄)₂PdCl₄, Li₂PdCl₄, Na₂PdCl₆, or K₂PdBr₄. It is preferable that the gold compound and the palladium compound be used in combination with thiocyanate or selenocyanate.

Examples of a sulfur sensitizer are hypo, a thiourea-based compound, a rhodanine-based compound, and sulfur-containing compounds described in U.S. Pat. Nos. 3,857,711, 4,266,018, and 4,054,457. The chemical sensitization can also be performed in the presence of a so-called chemical sensitization aid. Examples of a useful chemical sensitization aid are compounds, such as azaindene, azapyridazine, and azapyrimidine, which are known as compounds capable of suppressing fog and increasing sensitivity in the process of chemical sensitization. Examples of the chemical sensitization aid and the modifier are described in U.S. Pat. Nos. 2,131,038, 3,411,914, and 3,554,757, Jpn. Pat. Appln. KOKAI Publication No. 58-126526, and G. F. Duffin, Photographic Emulsion Chemistry, pages 138 to 143.

It is preferable to also perform gold sensitization for emulsions of the present invention. The amount of a gold sensitizer is preferably 1×10⁻⁴ to 1×10⁻⁷ mol, and more preferably 1×10⁻⁵ to 5×10⁻⁷ mol. A preferable amount of a palladium compound is 1×10⁻³ to 5×10⁻⁷. A preferable amount of a thiocyan compound or a selenocyan compound is 5×10⁻² to 1×10⁻⁶.

The amount of a sulfur sensitizer used in silver halide grains contained in emulsions manufactured by the method of the present invention is preferably 1×10⁻⁴ to 1×10⁻⁷ mol, and more preferably 1×10⁻⁵ to 5×10⁻⁷ mol per mol of a silver halide.

Selenium sensitization is a preferable sensitizing method for emulsions of the present invention. Known labile selenium compounds are used in the selenium sensitization. Practical examples of the selenium compound are colloidal metal selenium, selenoureas (e.g., N,N-dimethylselenourea and N,N-diethylselenourea), selenoketones, and selenoamides. In some cases, it is preferable to perform the selenium sensitization in combination with one or both of the sulfur sensitization and the noble metal sensitization. A preferable addition amount of a selenium sensitizer is 1×10⁻⁹ to 1×10⁻³ mol/mol Ag.

Silver halide emulsions of the present invention are preferably subjected to reduction sensitization between the start of the step a and the end of the step c, or after the end of the step c and before, during, or after chemical sensitization.

The reduction sensitization can be selected from a method of adding reduction sensitizers to a silver halide emulsion, a method called silver ripening in which grains are grown or ripened in a low-pAg ambient at pAg 1 to 7, and a method called high-pH ripening in which grains are grown or ripened in a high-pH ambient at pH 8 to 11. It is also possible to perform two or more of these methods together.

The method of adding reduction sensitizers is preferable in that the level of reduction sensitization can be finely adjusted.

Known examples of the reduction sensitizer are stannous chloride, ascorbic acid and its derivative, amines and polyamines, a hydrazine derivative, formamidinesulfinic acid, a silane compound, and a borane compound. In the reduction sensitization of the present invention, it is possible to selectively use these known reduction sensitizers or to use two or more types of compounds together. Preferable compounds as the reduction sensitizer are stannous chloride, thiourea dioxide, dimethylamineborane, and ascorbic acid and its derivative. Although the addition amount of the reduction sensitizers must be so selected as to meet the emulsion manufacturing conditions, a preferable amount is 10⁻⁷ to 10⁻³ mol per mol of a silver halide.

The reduction sensitizers are dissolved in water or a solvent, such as alcohols, glycols, ketones, esters, or amides, and the resultant solution is added during grain growth. Although adding to a reactor vessel in advance is also preferable, adding at a suitable timing during grain growth is more preferable. It is also possible that the reduction sensitizers are added in advance to an aqueous solution of a water-soluble silver salt or a water-soluble alkali halide, and thereafter, silver halide grains are precipitated by using this aqueous solution. Alternatively, a solution of the reduction sensitizers can be added separately several times or continuously over a long time period with grain growth.

It is preferable to use an oxidizer for silver during the process of manufacturing emulsions of the present invention. The oxidizer for silver means a compound having an effect of converting metal silver into silver ion. A particularly effective compound is the one that converts very fine silver grains, as a by-product in the process of formation of silver halide grains and chemical sensitization, into silver ion. The silver ion produced by the oxidizer can form a silver salt hard to dissolve in water, such as a silver halide, silver sulfide, or silver selenide, or a silver salt easy to dissolve in water, such as silver nitrate. The oxidizer for silver can be either an inorganic or organic substance. Examples of the inorganic oxidizer are ozone, hydrogen peroxide and its adduct (e.g., NaBO₂.H₂O₂.3H₂O, 2NaCO₃.3H₂O₂, Na₄P₂O₇.2H₂O₂, and 2Na₂SO₄.H₂O₂.2H₂O), peroxy acid salt (e.g., K₂S₂O₈, K₂C₂O₆, and K₂P₂O₈), a peroxy complex compound (e.g., K₂{Ti(O₂)C₂O₄}.3H₂O, 4K₂SO₄.Ti(O₂)OH.S₄.2H₂O, and Na₃{VO(O₂)(C₂H₄)₂.6H₂O}, permanganate (e.g., KMnO₄), an oxyacid salt such as chromate (e.g., K₂Cr₂O₇), a halogen element such as iodine and bromine, perhalogenate (e.g., potassium periodate), a salt of a high-valence metal (e.g., potassium hexacyanoferrate(II)), and thiosulfonate.

Examples of the organic oxidizer are quinones such as p-quinone, an organic peroxide such as peracetic acid and perbenzoic acid, and a compound for releasing active halogen (e.g., N-bromosuccinimide, chloramine T, and chloramine B).

Preferable inorganic oxidizers of the present invention are ozone, hydrogen peroxide and its adduct, a halogen element, and thiosulfonate, while preferable organic oxidizer are quinones. A combination of the reduction sensitization described above and the oxidizer for silver is preferable. In this case, the reduction sensitization can be performed after the oxidizer is used or vice versa, or the reduction sensitization and the use of the oxidizer can be performed at the same time. These methods can be selectively performed in the grain formation step or the chemical sensitization step.

Photographic emulsions used in the present invention can contain various compounds in order to prevent fog during the manufacturing process, storage, or photographic processing of a light-sensitive material, or to stabilize the photographic properties. Usable compounds are those known as an antifoggant or a stabilizer, for example, thiazoles, such as benzothiazolium salt, nitroimidazoles, nitrobenzimidazoles, chlorobenzimidazoles, bromobenzimidazoles, mercaptothiazoles, mercaptobenzothiazoles, mecaptobenzimidazoles, mercaptothiadiazoles, aminotriazoles, benzotriazoles, nitrobenzotriazoles, and mercaptotetrazoles (particularly 1-phenyl-5-mercaptotetrazole); mercaptopyrimidines; mercaptotriazines; a thioketo compound such as oxadolinethione; azaindenes, such as triazaindenes, tetrazaindenes (particularly 4-hydroxy-substituted(1,3,3a,7)tetrazaindenes), and pentazaindenes. For example, compounds described in U.S. Pat. Nos. 3,954,474 and 3,982,947 and Jpn. Pat. Appln. KOKOKU Publication No. 52-28660 can be used. One preferable compound is described in Jpn. Pat. Appln. KOKAI Publication No. 63-212932. Antifoggants and stabilizers can be added at any of several different timings, such as before, during, and after grain formation, during washing, during dispersion after washing, before, during, and after chemical sensitization, and before coating, in accordance with the intended application. The antifoggants and the stabilizers can be added during preparation of an emulsion to achieve their original fog preventing effect and stabilizing effect. In addition, the antifoggants and the stabilizers can be used for various purposes of, e.g., controlling crystal habit of grains, decreasing a grain size, decreasing the solubility of grains, controlling chemical sensitization, and controlling an arrangement of dyes.

Photographic emulsions manufactured in accordance with the present invention are preferably subjected to spectral sensitization by methine dyes and the like in order to achieve the effects of the present invention. Usable dyes involve a cyanine dye, a merocyanine dye, a composite cyanine dye, a composite merocyanine dye, a holopolar cyanine dye, a hemicyanine dye, a styryl dye, and a hemioxonole dye. Particularly useful dyes are those belonging to a cyanine dye, a merocyanine dye, and a composite merocyanine dye. Any nucleus commonly used as a basic heterocyclic nucleus in cyanine dyes can be applied to these dyes. Examples of an applicable nucleus are a pyrroline nucleus, an oxazoline nucleus, a thiozoline nucleus, a pyrrole nucleus, an oxazole nucleus, a thiazole nucleus, a selenazole nucleus, an imidazole nucleus, a tetrazole nucleus, and a pyridine nucleus; a nucleus in which an aliphatic hydrocarbon ring is fused to any of the above nuclei; and a nucleus in which an aromatic hydrocarbon ring is fused to any of the above nuclei, e.g., an indolenine nucleus, a benzindolenine nucleus, an indole nucleus, a benzoxadole nucleus, a naphthoxazole nucleus, a benzthiazole nucleus, a naphthothiazole nucleus, a benzoselenazole nucleus, a benzimidazole nucleus, and a quinoline nucleus. These nuclei can be substituted on a carbon atom.

It is possible for a merocyanine dye or a composite merocyanine dye to utilize a 5- to 6-membered heterocyclic nucleus as a nucleus having a ketomethylene structure. Examples are a pyrazoline-5-one nucleus, a thiohydantoin nucleus, a 2-thiooxazolidine-2,4-dione nucleus, a thiazolidine-2,4-dione nucleus, a rhodanine nucleus, and a thiobarbituric acid nucleus.

Although these sensitizing dyes can be used singly, they can also be used together. The combination of sensitizing dyes is often used for a supersensitization purpose. Representative examples of the combination are described in U.S. Pat. Nos. 2,688,545, 2,977,229, 3,397,060, 3,522,052, 3,527,641, 3,617,293, 3,628,964, 3,666,480, 3,672,898, 3,679,428, 3,703,377, 3,769,301, 3,814,609, 3,837,862, and 4,026,707, British Patent Nos. 1,344,281 and 1,507,803, Jpn. Pat. Appln. KOKOKU Publication Nos. 43-4936 and 53-12,375, and Jpn. Pat. Appln. KOKAI Publication Nos. 52-110,618 and 52-109,925.

In addition to the sensitizing dyes, emulsions can contain dyes having no spectral sensitizing effect or substances not essentially absorbing visible light and presenting supersensitization.

The sensitizing dyes can be added to an emulsion at any point in preparation of an emulsion, which is conventionally known to be useful. Most ordinarily, the addition is performed after completion of chemical sensitization and before coating. However, it is possible to perform the addition at the same timing as addition of chemical sensitizing dyes to perform spectral sensitization and chemical sensitization simultaneously, as described in U.S. Pat. Nos. 3,628,969 and 4,225,666. It is also possible to perform the addition prior to chemical sensitization, as described in Jpn. Pat. Appln. KOKAI Publication No. 58-113928, or before completion of formation of a silver halide grain precipitation to start spectral sensitization. Alternatively, as disclosed in U.S. Pat. No. 4,225,666, these compounds can be added separately; a portion of the compounds may be added prior to chemical sensitization, while the remaining portion is added after that. Furthermore, the compounds can be added at any timing during formation of silver halide grains, including the method disclosed in U.S. Pat. No. 4,183,756.

The addition amount can be 4×10-6 to 8×10⁻³ mol per mol of a silver halide. However, for a more preferable silver halide grain size of 0.2 to 1.2 μm, an addition amount of about 5×10⁻⁵ to 2×10⁻³ mol is more effective.

Silver halide emulsions manufactured by the method of the present invention can be added to light-sensitive layers of all of blue-, green-, and red-sensitive layers in a silver halide photosensitive material.

In addition to the several different additives described above which can be used in the sensitive material according to this technique, a variety of other additives can also be used in accordance with the intended use.

The details of these additives are described in Research Disclosures Item 17643 (December, 1978), Item 18716 (November, 1979), and Item 308119 (December, 1989), and these portions are summarized in a table below.

| | Additives | RD17643 | RD18716 | RD308119 |
|---|---|---|---|---|
| 1. | Chemical | page 23 | page 648, right | page 996 |
| | sensitizers | | column | |
| 2. | Sensitivity | | page 648, right | |
| | increasing agents | | column | |
| 3. | Spectral sensiti- | pages 23- | page 648, right | page 996, right |
| | zers, super | 24 | column to page | column to page |
| | sensitizers | | 649, right column | 998, right column |
| 4. | Brighteners | page 24 | | page 998, right |
| | | | | column |
| 5. | Antifoggants and | pages 24- | page 649, right | page 998, right |
| | stabilizers | 25 | column | column to page 1,000, |
| | | | | right column |
| 6. | Light absorbent, | pages 25- | page 649, right | page 1,000, left |
| | filter dye, ultra- | 26 | column to page | column to page 1,003, |
| | violet absorbents | | 650, left column | right column |
| 7. | Stain preventing | page 25, | page 650, left to | page 1,002, right |
| | agents | right column | right columns | column |
| 8. | Dye image | page 25 | page 650, left | page 1,002, right |
| | stabilizer | | column | column |
| 9. | Hardening agents | page 26 | page 651, left | page 1,004, right |
| | column | | | column to page 1,005, |
| | | | | left column |
| 10. | Binder | page 26 | ″ | page 1,003, right |
| | | | | column to page 1,004, |
| | | | | right column |
| 11. | Plasticizers, | page 27 | page 650, right | page 1,006, left to |
| | lubricants | | column | right columns |
| 12. | Coating aids, | pages 26- | page 650, right | page 1,005, left |
| | surface active | 27 | column | column to page 1,006, |
| | agents | | | left column |
| 13. | Antistatic agents | page 27 | page 650, right | page 1,006, right |
| | | | column | column to page 1,007, |
| | | | | left column |
| 14. | Matting agent | | | page 1,008, left |
| | | | | column to page 1,009, |
| | | | | left column |

Techniques such as a layer arrangement technique, silver halide emulsions, dye formation couplers, functional couplers such as DIR couplers, various additives, and development usable in the emulsions of the present invention and photographic light-sensitive materials using the emulsions are described in European Patent No. 0565096A1 (published in Oct. 13, 1993) and the patents cited in it. The individual items and the corresponding portions are enumerated below.

1. Layer arrangements: page 61, lines 23-35, page 61, line 41-page 62, line 41

2. Interlayers: page 61, lines 36-40

3. Interlayer effect imparting layers: page 62, lines 15-18

4. Silver halide halogen compositions: page 62, lines 21-25

5. Silver halide grain crystal habits: page 62, lines 26-30

6. Emulsion preparation methods: page 62, lines 35-40

7. Silver halide grain size distribution: page 62, lines 41-42

8. Tabular grains: page 62, lines 43-46

9. Internal structures of grains: page 62, lines 47-53

10. Latent image formation types of emulsions: page 62, line 52-page 63, line 5

11. Physical ripening-chemical ripening of emulsions: page 63, lines 6-9

12. Use of emulsion mixtures: page 63, lines 10-13

13. Fogged emulsions: page 63, lines 14-31

14. Non-light-sensitive emulsions: page 63, lines 32-43

15. Photographic additives: described in Research Disclosure (RD) Item 17643 (December, 1978), RD Item 18716 (November, 1979), and RD Item 307105 (November, 1989). The individual items and the corresponding portions are presented below.

| | Additives | RD17643 | RD18716 | RD307105 |
|---|---|---|---|---|
| (1) | Chemical | page 23 | page 648, right | page 866 |
| | sensitizers | | column | |
| (2) | Sensitivity | | page 648, right | |
| | increasing agents | | column | |
| (3) | Spectral sensiti- | pages 23- | page 648, right | pages 866-868 |
| | zers, super | 24 | column to page | |
| | sensitizers | | 649, right column | |
| (4) | Brighteners | page 24 | | page 868 |
| (5) | Antifoggants and | pages 24- | page 649, right | pages 868-870 |
| | stabilizers | 25 | column | |
| (6) | Light absorbent, | pages 25- | page 649, right | page 873 |
| | filter dye, ultra- | 26 | column to page | |
| | violet absorbents | | 650, left column | |
| (7) | Stain preventing | page 25, | page 650, left to | page 872 |
| | agents | right column | right columns | |
| (8) | Dye image | page 25 | page 650, left | page 872 |
| | stabilizer | | column | |
| (9) | Hardening agents | page 26 | page 651, left | pages 874-875 |
| | column | | | |
| (10) | Binder | page 26 | ″ | pages 873-874 |
| (11) | Plasticizers, | page 27 | page 650, right | page 876 |
| | lubricants | | column | |
| (12) | Coating aids, | pages 26- | page 650, right | pages 875-876 |
| | surface active | 27 | column | |
| | agents | | | |
| (13) | Antistatic agents | page 27 | page 650, right | pages 876-877 |
| | | | column | |
| (14) | Matting agent | | | pages 878-879 |

| | |
|---|---|
| 16. | Formaldehyde scavengers: page 64, lines 54-57 |
| 17. | Mercapto-based antifoggants: page 65, lines 1-2 |
| 18. | Agents releasing, e.g., fogging agent: page 65, |
| | lines 3-7 |
| 19. | Dyes: page 65, lines 7-10 |
| 20. | General color couplers: page 65, lines 11-13 |
| 21. | Yellow, magenta, and cyan couplers: page 65, |
| | lines 14-25 |
| 22. | Polymer couplers: page 65, lines 26-28 |
| 23. | Diffusing dye forming couplers: page 65, |
| | lines 29-31 |
| 24. | Colored couplers: page 65, lines 32-38 |
| 25. | General functional couplers: page 65, |
| | lines 39-44 |
| 26. | Bleaching accelerator release couplers: page 65, |
| | lines 45-48 |
| 27. | Development accelerator release couplers: page 65, |
| | lines 49-53 |
| 28. | Other DIR couplers: page 65, line 54-page 66, |
| | line 4 |
| 29. | Coupler diffusing methods: page 66, lines 5-28 |
| 30. | Antiseptic • mildewproofing agents: page 66, |
| | lines 29-33 |
| 31. | Types of light-sensitive materials: page 66, |
| | lines 34-36 |
| 32. | Light-sensitive layer film thickness and swell |
| | speed: page 66, line 40-page 67, line 1 |
| 33. | Back layers: page 67, lines 3-8 |
| 34. | General development processing: page 67, |
| | lines 9-11 |
| 35. | Developers and developing agents: page 67, |
| | lines 12-30 |
| 36. | Developer additives: page 67, lines 31-44 |
| 37. | Reversal processing: page 67, lines 45-56 |
| 38. | Processing solution aperture ratio: page 67, |
| | line 57-page 68, line 12 |
| 39. | Development time: page 68, lines 13-15 |
| 40. | Bleach-fix, bleaching, and fixing: page 68, |
| | line 16-page 69, line 31 |
| 41. | Automatic processor: page 69, lines 32-40 |
| 42. | Washing, rinsing, and stabilization: page 69, |
| | line 41-page 70, line 18 |
| 43. | Replenishment and reuse of processing solutions: |
| | page 70, lines 19-23 |
| 44. | Incorporation of developing agent into |
| | light-sensitive material: page 70, lines 24-33 |
| 45. | Development temperature: page 70, lines 34-38 |
| 46. | Application to film with lens: page 70, |
| | lines 39-41 |

It is also possible to preferably use a bleaching solution described in European Patent No. 602600 which contains 2-pyridinecarboxylic acid or 2,6-pyridinedicarboxylic acid, ferric salt such as ferric nitrate, and persulfate. When this bleaching solution is to be used, it is preferable to interpose a stop step and a washing step between the color development step and the bleaching step and use organic acid such as acetic acid, succinic acid, or maleic acid as the stop bath. Furthermore, for the purposes of pH adjustment and bleaching fog, the bleaching solution preferably contains 0.1 to 2 mols/*liter* of organic acid such as acetic acid, succinic acid, maleic acid, glutaric acid, or adipic acid.

### EXAMPLES

The present invention will be described in detail below by way of its examples, but the invention is not restricted to these examples.

### Example 1

<Preparation of Emulsions>

Preparation of Seed Emulsion

Silver bromide tabular grains having an average equivalent-circle diameter of 0.60 μm, a variation coefficient of an equivalent-circle diameter of 20%, and an average thickness of 0.10 μm were prepared as a seed crystal emulsion.

Preparation of Silver Iodide Fine Grain Emulsion

1700 mL of an aqueous solution containing 0.23 g of KI and 23 g of gelatin was held at 40° C. and stirred. An aqueous AgNO₃ (153 g) solution and an aqueous KI (149.5 g) solution were added by the double-jet method over 13 min. After desalting, 78 g of gelatin were added, and the pH was adjusted to 5.8 at 40° C. The resultant silver iodide fine grains contained 0.72 mol of Ag and 31 g of gelatin per 1 Kg of the emulsion and had an average equivalent-circle diameter of 0.047 μm and a variation coefficient of an equivalent-circle diameter of 20%.

Preparation of Emulsion 1-A

1,200 mL of an aqueous solution containing 2.3 g of potassium bromide and 33 g of gelatin was held at 75° C. and stirred. After 120 g of silver bromide tabular seed crystal were added, an aqueous solution containing 130 g of silver nitrate and 566 mL of an aqueous halide solution containing 83.6 g of potassium bromide and 13.8 g of potassium iodide were added by the double-jet method at accelerated flow rates over 45 min while the pAg of the solution was held at 8.7. After the addition was complete, the temperature was decreased to 55° C. The pAg of the solution at that time was found to be 8.90. 260 mL of an aqueous solution containing 7.1 g of silver nitrate and 280 mL of an aqueous solution containing 5.3 g of potassium iodide were added by the double-jet method over 5 min while the flow rates were held constant, and the pAg was adjusted to 9.3. In addition, an aqueous solution containing 66.4 g of silver nitrate and an aqueous solution containing 43 g of potassium bromide were added by the double-jet method, and the resultant emulsion was cooled. After washing, gelatin was added, and the pH and the pAg were adjusted to 5.8 and 8.8, respectively, at 40° C.

This emulsion was tabular silver iodobromide grains in which grains having an aspect ratio of 3 or more and an equivalent-circle diameter of 1.4 μm or more accounted for 20% of the projected area of all grains, and which had an average equivalent-circle diameter of 1.20 μm, a variation coefficient of an equivalent-circle diameter of 22%, an average thickness of 0.28 μm, an average aspect ratio of 4.3, and a total silver iodide content of 8.8 mol %.

Preparation of Emulsion 1-B

1,200 mL of an aqueous solution containing 3.0 g of potassium bromide and 40 g of gelatin were held at 75° C. and stirred. After 67 g of silver bromide tabular seed crystal were added, 530 mL of an aqueous solution containing 169.4 g of silver nitrate and 600 mL of an aqueous halide solution containing 116 g of potassium bromide and 4.5 g of potassium iodide were added by the double-jet method at accelerated flow rates over 60 min.

The resultant emulsion was cooled to 55° C., 150 mL of an aqueous solution containing 5.2 g of silver nitrate and 540 mL of an aqueous solution containing 5.1 g of potassium iodide were added over 10 min while the flow rates were held constant, and the emulsion was kept stirred for another 2 min.

In addition, 250 mL of an aqueous solution containing 86.3 g of silver nitrate and 250 mL of an aqueous solution containing 61 g of potassium bromide were added to the emulsion by the double-jet method, and the emulsion was cooled. After washing, gelatin was added, and the pH and the pAg were adjusted to 5.8 and 8.8, respectively, at 40° C.

This emulsion was tabular silver iodobromide grains in which grains having an aspect ratio of 3 or more and an equivalent-circle diameter of 1.4 μm or more accounted for 50% of the projected area of all grains, and which had an average equivalent-circle diameter of 1.48 μm, a variation coefficient of an equivalent-circle diameter of 20%, an average thickness of 0.33 μm, an average aspect ratio of 5, and a total silver iodide content of 3.6 mol %.

Preparation of Emulsion 1-C.

Preparation of Host Tabular Grains (Step a)

1,200 mL of an aqueous solution containing 3.0 g of potassium bromide and 40 g of gelatin were held at 75° C. and stirred. After 67 g of silver bromide tabular seed crystal were added, an aqueous solution containing 169.4 g of silver nitrate and 600 mL of an aqueous halide solution containing 116 g of potassium bromide and 16.1 g of potassium iodide were added by the double-jet method at accelerated flow rates over 90 min while the pAg of the solution was held at 7.9.

Addition of Slightly Soluble Silver Halide Emulsion (Step b)

While the emulsion prepared in the (step a) described above was maintained at 75° C., the pAg was adjusted to 9.5 by an aqueous KBr solution. After the emulsion was stirred for 1 min, 42.7 g of a silver iodide fine grain emulsion were abruptly added within 10 sec.

Formation of Outermost Shell (Step c)

Furthermore, when 90 sec elapsed, 250 mL of an aqueous solution containing 86.3 g of silver nitrate were added at a fixed flow rate over 20 min. The pAg after the addition was found to be 8.0. After normal washing was performed, gelatin was added, and the pH and the pAg were adjusted to 5.8 and 8.8, respectively, at 40° C.

This emulsion was tabular silver iodobromide grains in which grains having an aspect ratio of 3 or more and an equivalent-circle diameter of 1.4 μm or more accounted for 40% of the projected area of all grains, and which had an average equivalent-circle diameter of 1.25 μm, a variation coefficient of an equivalent-circle diameter of 18%, an average thickness of 0.44 μm, an average aspect ratio of 2.8, and a total silver iodide content of 8.4 mol %.

Preparation of Emulsion 1-D

Preparation of Host Tabular Grains (Step a)

1,200 mL of an aqueous solution containing 3.0 g of potassium bromide and 40 g of gelatin were held at 75° C. and stirred. After 67 g of silver bromide tabular seed crystal were added, an aqueous solution containing 145.4 g of silver nitrate and 600 mL of an aqueous halide solution containing 108 g of potassium bromide and 4.5 g of potassium iodide were added by the double-jet method at accelerated flow rates over 90 min while the pAg of the solution was held at 9.0.

Addition of Slightly Soluble Silver Halide Emulsion (Step b)

While the emulsion prepared in the (step a) described above was maintained at 75° C., the pAg was adjusted to 9.5 by an aqueous KBr solution. After the emulsion was stirred for 1 min, 42.7 g of a silver iodide fine grain emulsion were abruptly added within 10 sec.

Formation of Outermost Shell (Step c)

Furthermore, when 90 sec elapsed, 250 mL of an aqueous solution containing 110.3 g of silver nitrate were added at a fixed flow rate by the double-jet method. The pAg after the addition was found to be 8.0. After normal washing was performed, gelatin was added, and the pH and the pAg were adjusted to 5.8 and 8.8, respectively, at 40° C.

This emulsion was tabular silver iodobromide grains in which grains having an aspect ratio of 3 or more and an equivalent-circle diameter of 1.4 μm or more accounted for 65% of the projected area of all grains, and which had an average equivalent-circle diameter of 1.50 μm, a variation coefficient of an equivalent-circle diameter of 22%, an average thickness of 0.30 μm, an average aspect ratio of 5, and a total silver iodide content of 3.6 mol %.

Preparation of Emulsion 1-E

Preparation of Host Tabular Grains (Step a)

1,200 mL of an aqueous solution containing 3.0 g of potassium bromide and 40 g of gelatin were held at 75° C. and stirred. After 67 g of silver bromide tabular seed crystal were added, an aqueous solution containing 169.4 g of silver nitrate and 600 mL of an aqueous halide solution containing 116 g of potassium bromide and 11.5 g of potassium iodide were added by the double-jet method at accelerated flow rates over 100 min while the pAg of the solution was held at 8.9.

Addition of Slightly Soluble Silver Halide Emulsion (Step b)

While the emulsion prepared in the (step a) described above was maintained at 75° C., the pAg was adjusted to 9.5 by an aqueous KBr solution. After the emulsion was stirred for 1 min, 59.8 g of a silver iodide fine grain emulsion were abruptly added within 10 sec.

Formation of Outermost Shell (Step c)

Furthermore, when 90 sec elapsed, 250 mL of an aqueous solution containing 86.3 g of silver nitrate were added at a fixed flow rate over 20 min. The pAg after the addition was found to be 8.0. After normal washing was performed, gelatin was added, and the pH and the pAg were adjusted to 5.8 and 8.8, respectively, at 40° C.

This emulsion was tabular silver iodobromide grains in which grains having an aspect ratio of 3 or more and an equivalent-circle diameter of 1.4 μm or more accounted for 65% of the projected area of all grains, and which had an average equivalent-circle diameter of 1.50 μm, a variation coefficient of an equivalent-circle diameter of 18%, an average thickness of 0.30 μm, an average aspect ratio of 5.0, and a total silver iodide content of 7.0 mol %.

Preparation of Emulsion 1-F

Preparation of Host Tabular Grains (Step a)

1,200 mL of an aqueous solution containing 3.0 g of potassium bromide and 40 g of gelatin were held at 75° C. and stirred. After 67 g of silver bromide tabular seed crystal were added, an aqueous solution containing 200.5 g of silver nitrate and 600 mL of an aqueous halide solution containing 138 g of potassium bromide and 4.5 g of potassium iodide were added by the double-jet method at accelerated flow rates over 90 min while the pAg of the solution was held at 8.8.

Addition of Slightly Soluble Silver Halide Emulsion (Step b)

While the emulsion prepared in the (step a) described above was maintained at 75° C., the pAg was adjusted to 9.5 by an aqueous KBr solution. After the emulsion was stirred for 1 min, 28.5 g of a silver iodide fine grain emulsion were abruptly added within 10 sec.

Formation of Outermost Shell (Step c)

Furthermore, when 90 sec elapsed, 250 mL of an aqueous solution containing 55.2 g of silver nitrate were added at a fixed flow rate over 20 min. The pAg after the addition was found to be 8.0. After normal washing was performed, gelatin was added, and the pH and the pAg were adjusted to 5.8 and 8.8, respectively, at 40° C.

This emulsion was tabular silver iodobromide grains in which grains having an aspect ratio of 3 or more and an equivalent-circle diameter of 1.4 μm or more accounted for 70% of the projected area of all grains, and which had an average equivalent-circle diameter of 1.60 μm, a variation coefficient of an equivalent-circle diameter of 18%, an average thickness of 0.27 μm, an average aspect ratio of 6, and a total silver iodide content of 3.0 mol %.

The tabular silver halide emulsions (1-A) to (1-F) obtained by the above preparation methods were heated to 56° C., and dipotassium iridium hexachloride, sensitizing dyes (ExS-4), (ExS-7), and (ExS-8) to be presented later, sodium thiosulfate, chloroauric acid, potassium thiocyanate, and N,N′-dimethylselenourea were added to optimally perform chemical sensitization. “Optimally” herein mentioned indicates conditions under which 1/100-sec exposure sensitivity is highest.

The characteristics of the tabular emulsion grains (1-A) to (1-F) obtained as described above are shown in Table 1 below.

TABLE 1

| Emulsion | Equivalent-sphere | Equivalent-circle | Aspect | | |
|---|---|---|---|---|---|
| No. | diameter μm | diameter μm | ratio | SAg/Cag | (Step b) |
| 1-A | 0.85 | 1.20 | 4.3 | 3/7 | (Solution of KI) |
| 1-B | 1.00 | 1.48 | 5 | 3/7 | (Solution of KI) |
| 1-C | 1.00 | 1.25 | 2.8 | 3/7 | Silver iodide |
| | | | | | fine grains |
| 1-D | 1.00 | 1.50 | 5 | 4/6 | Silver iodide |
| | | | | | fine grains |
| 1-E | 1.00 | 1.50 | 5 | 3/7 | Silver iodide |
| | | | | | fine grains |
| 1-F | 1.00 | 1.60 | 6 | 2/8 | Silver iodide |
| | | | | | fine grains |
| 2-A | 1.40 | 2.00 | 7 | 0/10 | — |
| 2-B | 1.40 | 2.00 | 7 | 4/6 | Silver iodide |
| | | | | | fine grains |
| 2-C | 1.40 | 2.00 | 7 | 3/7 | Silver iodide |
| | | | | | fine grains |
| 2-D | 1.40 | 2.00 | 7 | 2/8 | Silver iodide |
| | | | | | fine grains |
| 2-E | 1.40 | 2.00 | 7 | 1/9 | Silver iodide |
| | | | | | fine grains |
| 3-A | 1.80 | 3.20 | 8 | 4/6 | Silver iodide |
| | | | | | fine grains |
| 3-B | 1.80 | 3.40 | 10 | 3/7 | Silver iodide |
| | | | | | fine grains |
| 3-C | 1.80 | 3.55 | 12 | 2/8 | Silver iodide |
| | | | | | fine grains |
| 3-D | 1.80 | 3.85 | 15 | 1/9 | Silver iodide |
| | | | | | fine grains |

| | | | Ratio accounted for | |
|---|---|---|---|---|
| | | Surface | by tabular grains ¹⁾ | |
| | Number of | iodide | in the total | |
| Emulsion | dislocation | amount | projected area of all | |
| No. | lines | (mol %) | grains | Remarks |
| 1-A | 10 or more | 6.0 | 20% | Comparative example |
| 1-B | 10 or more | 2.0 | 50% | Comparative example |
| 1-C | 10 or more | 3.0 | 40% | Comparative example |
| 1-D | 10 or more | 2.0 | 65% | Comparative example |
| 1-E | 10 or more | 5.5 | 65% | Present invention |
| 1-F | 10 or more | 2.0 | 70% | Present invention |
| 2-A | None | 2.0 | 80% | Comparative example |
| 2-B | 10 or more | 2.0 | 80% | Comparative example |
| 2-C | 10 or more | 2.0 | 80% | Comparative example |
| 2-D | 10 or more | 2.0 | 80% | Present invention |
| 2-E | 10 or more | 2.0 | 80% | Present invention |
| 3-A | 10 or more | 6.0 | 90% | Comparative example |
| 3-B | 10 or more | 4.0 | 90% | Comparative example |
| 3-C | 10 or more | 4.0 | 90% | Present invention |
| 3-D | 10 or more | 4.0 | 90% | Present invention |

Note ¹⁾Tabular grains having an aspect ratio of 3 or more and an equivalent-circle diameter of 1.4 μm or more

<Formation and Development of Coated Samples>

Sample Nos. 101 to 106 were formed by coating a cellulose triacetate film support having an undercoat layer with the emulsions (1-A) to (1-F) chemically sensitized as described above under coating conditions as shown in Table 2 below by forming a protective layer.

TABLE 2

| | |
|---|---|
| (1) Emulsion layer | |
| Any one of emulsion Nos. 1-A to 1-F | (Ag 1.2 g/m²) |
| Coupler | (1.5 × 10⁻³ mol/m²) |

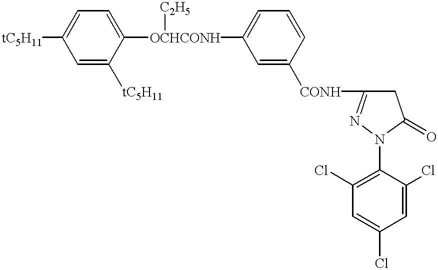

| Tricresylphosphate | (1.10 g/m²) |
|---|---|
| Gelatin | (2.30 g/m²) |
| (2) Protective layer | |
| 2,4-dichloro-6-hydroxy-s-triazine sodium salt | (0.08 g/m²) |
| Gelatin | (1.80 g/m²) |
| Antifoggant | (8.4 × 10⁻³ mol/m²) |
| 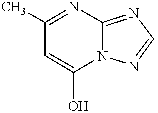 | |

These samples were left to stand at 40° C. and a relative humidity of 70% for 14 hours. The resultant samples were exposed for 1/100 sec through a gelatin filter SC-50 manufactured by Fuji Photo Film Co., Ltd. and a continuous wedge.

By using a negative processor FP-350 manufactured by Fuji Photo Film Co., Ltd., the exposed samples were processed by the following method (until the accumulated replenisher amount of each solution was three times the mother solution tank volume).

(Processing Method)

| | | Tempera- | |
|---|---|---|---|
| Step | Time | ture | Replenishment rate |
| Color | 2 min. 45 sec. | 38° C. | 45 m*liter* |
| development | | | |
| Bleaching | 1 min. 00 sec. | 38° C. | 20 m*liter* |
| | | | bleaching solution |
| | | | overflow was |
| | | | entirely flowed into |
| | | | bleach-fix tank |
| Bleach-fix | 3 min. 15 sec. | 38° C. | 30 m*liter* |
| Washing (1) | 40 sec. | 35° C. | counter flow piping |
| | | | from (2) to (1) |
| Washing (2) | 1 min. 00 sec. | 35° C. | 30 m*liter* |
| Stabili- | 40 sec. | 38° C. | 20 m*liter* |
| zation | | | |
| Drying | 1 min. 15 sec. | 55° C. | |

*The replenishment rate is represented by a value per 1.1 m of a 35-mm wide sample (equivalent to one 24 Ex. film).

The compositions of the processing solutions are presented below.

| | Tank | | Replenisher | |
|---|---|---|---|---|
| Color developer | solution (g) | | (g) | |
| Diethylenetriamine | 1.0 | | 1.1 | |
| pentaacetic acid | | | | |
| 1-hydroxyethylidene- | 2.0 | | 2.0 | |
| 1,1-diphosphonic acid | | | | |
| Sodium sulfite | 4.0 | | 4.4 | |
| Potassium carbonate | 30.0 | | 37.0 | |
| Potassium bromide | 1.4 | | 0.7 | |
| Potassium iodide | 1.5 | mg | | |
| Hydroxylaminesulfate | 2.4 | | 2.8 | |
| 4-{N-ethyl-N-(β-hydroxy | 4.5 | | 5.5 | |
| ethyl) amino}-2-methyl | | | | |
| aniline sulfate | | | | |
| Water to make | 1.0 | L | 1.0 | L |
| pH (adjusted by potassium | 10.05 | | 10.10 | |
| hydroxide and sulfuric | | | | |
| acid) | | | | |

| | common to tank solution and | |
|---|---|---|
| Bleaching solution | replenisher (g) | |
| Ferric ammonium ethylenediamine | 120.0 | |
| tetraacetate dihydrate | | |
| Disodium ethylenediamine tetraacetate | 10.0 | |
| Ammonium bromide | 100.0 | |
| Ammonium nitrate | 10.0 | |
| Bleaching accelerator | 0.005 | mol |
| (CH₃)₂N—CH₂—CH₂—S—S—CH₂—CH₂— | | |
| N(CH₃)₂ · 2HCl | | |
| Ammonia water (27%) | 15.0 | mL |
| Water to make | 1.0 | L |
| pH (adjusted by ammonia water | 6.3 | |
| and sulfuric acid) | | |

| | Tank | | Replenisher | |
|---|---|---|---|---|
| Bleach-fix bath | solution (g) | | (g) | |
| Ferric ammonium ethylene | 50.0 | | — | |
| diaminetetraacetate | | | | |
| dihydrate | | | | |
| Disodium ethylenediamine | 5.0 | | 2.0 | |
| tetraacetate | | | | |
| Ammonium sulfite | 12.0 | | 20.0 | |
| Aqueous ammonium | 240.0 | mL | 400.0 | mL |
| thiosulfate solution | | | | |
| (700 g/*liter*) | | | | |
| Ammonia water (27%) | 6.0 | mL | — | |
| Water to make | 1.0 | L | 1.0 | L |
| pH (adjusted by ammonia | 7.2 | | 7.3 | |
| water and acetic acid) | | | | |

Washing Water Common to Tank Solution and Replenisher

Tap water was supplied to a mixed-bed column filled with an H type strongly acidic caution exchange resin (Amberlite IR-120B: available from Rohm & Haas Co.) and an OH type strongly basic anion exchange resin (Amberlite IR-400) to set the concentrations of calcium and magnesium to be 3 mg/*liter* or less. Subsequently, 20 mg/*liter* of sodium isocyanuric acid dichloride and 0.15 g/*liter* of sodium sulfate were added. The pH of the solution ranged from 6.5 to 7.5.

| | common to tank solution and | |
|---|---|---|
| Stabilizer | Replenisher (g) | |
| Sodium p-toluenesulfinate | 0.03 | |
| Polyoxyethylene-p-monononyl | 0.2 | |
| phenylether | | |
| (average polymerization degree 10) | | |
| Disodium ethylenediaminetetraacetate | 0.05 | |
| 1,2,4-triazole | 1.3 | |
| 1,4-bis(1,2,4-triazole-1-ylmethyl) | 0.75 | |
| piperazine | | |
| Water to make | 1.0 | L |
| pH | 8.5 | |

The density of each processed sample was measured through a green filter. The sensitivity is indicated by a relative value of the reciprocal of an exposure amount by which a density of fog density+0.2 was given.

The following three different tests were conducted to evaluate the pressure resistance of each emulsion-coated sample.

(1) Pressure Resistance by Bending

Each sample was moisture-conditioned to 25° C. and 55% and bent by a testing machine which bent the sample at an angle of 156° such that the emulsion surface was inside, and exposure and development were performed by the methods described above. Fog produced in the bent portion of each resultant sample was measured by a microdensitometer.

(2) Pressure Resistance by Scratching by Thin Needle

Each sample was moisture-conditioned to 25° C. and 55%, and the emulsion surface was scratched in a fixed direction with a thin needle 50 μm in diameter to which a load of 4 g was applied. Thereafter, exposure and development were performed by the methods described above. A reduction of the image density in the scratched portion of each resultant sample was measured.

(3) Pressure Resistance by Scratching by Thin Needle in Swelled State

After each coated sample exposed by a similar method was dipped in hot water held at 35° C. for 30 sec, the emulsion surface was scratched in a fixed direction with a thin needle 50 μm in diameter to which a load of 4 g was applied, and development was performed. Fog produced in the scratched portion of the sample was measured by a microdensitometer.

Table 3 shows the sensitivity of each coated sample and the results of the pressure resistance of each coated sample obtained by the above testing methods.

TABLE 3

| | | | | Pressure | Pressure | |
|---|---|---|---|---|---|---|
| | | | Pressure marks | desensitization | marks in | |
| | | | by thin needle | by thin needle | swelled state | |
| | | | (fog after | (density after | (fog after | |
| | | | pressure) - | pressure) - | pressure) - | |
| Sample | Emulsion | Relative | (fog before | (density before | (fog before | |
| No. | No. | sensitivity | pressure) | pressure) | pressure) | Remarks |
| 101 | 1-A | 76 | 0.20 | 0 | 0.50 | Comparative |
| | | | | | | example |
| 102 | 1-B | 100 | 0.50 | +0.15 | 0.70 | Comparative |
| | | (Standard) | | | | example |
| 103 | 1-C | 89 | 0.30 | −0.05 | 0.30 | Comparative |
| | | | | | | example |
| 104 | 1-D | 112 | 0.30 | −0.30 | 0.30 | Comparative |
| | | | | | | example |
| 105 | 1-E | 126 | 0.20 | −0.05 | 0.10 | Present |
| | | | | | | invention |
| 106 | 1-F | 126 | 0.15 | −0.02 | 0.05 | Present |
| | | | | | | invention |

Table 3 reveals that the samples 105 and 106 using the emulsions 1-E and 1-F of the present invention are superior in sensitivity, pressure marks, and pressure resistance desensitization to the samples 101 to 104 using the comparative emulsions 1-A to 1-D. In particular, the sample 106 has high pressure resistance.

### Example 2

Preparation of Emulsion 2-A

1,200 mL of an aqueous solution containing 3.0 g of potassium bromide and 40 g of gelatin were held at 75° C. and stirred. After 34 g of silver bromide tabular seed crystal were added, an aqueous solution containing 232.0 g of silver nitrate and 600 mL of an aqueous halide solution containing 174 g of potassium bromide and 6.3 g of potassium iodide were added by the double-jet method at accelerated flow rates over 140 min while the pAg of the solution was held at 8.0.

In addition, 130 mL of an aqueous solution containing 28.3 g of silver nitrate and an aqueous solution containing 17.8 g of potassium bromide were added by the double-jet method over 15 min while the pAg of the solution was held at 8.0.

This emulsion was tabular silver iodobromide grains in which grains having an aspect ratio of 3 or more and an equivalent-circle diameter of 1.4 μn or more accounted for 80% of the projected area of all grains, and which had an average equivalent-circle diameter of 1.40 μm, a variation coefficient of an equivalent-circle diameter of 18%, an average thickness of 0.29 μm, an average aspect ratio of 7.0, and a total silver iodide content of 2.3 mol %.

Preparation of Emulsion 2-B

Preparation of Host Tabular Grains (Step a)

1,200 mL of an aqueous solution containing 3.0 g of potassium bromide and 40 g of gelatin were held at 75° C. and stirred. After 34 g of silver bromide tabular seed crystal were added, an aqueous solution containing 121.4 g of silver nitrate and 600 mL of an aqueous halide solution containing 93.3 g of potassium bromide and 4.3 g of potassium iodide were added by the double-jet method at accelerated flow rates over 60 min while the pAg of the solution was held at 8.2.

In addition, 130 mL of an aqueous solution containing 28.3 g of silver nitrate and an aqueous solution containing 17.8 g of potassium bromide were added by the double-jet method over 15 min while the pAg of the solution was held at 8.0.

Addition of Slightly Soluble Silver Halide Emulsion (Step b)

While the emulsion prepared in the (step a) described above was maintained at 75° C., the pAg was adjusted to 9.5 by an aqueous KBr solution. After the emulsion was stirred for 1 min, 44 g of a silver iodide fine grain emulsion were abruptly added within 10 sec.

Formation of Outermost Shell (Step c)

Furthermore, when 90 sec elapsed, 300 mL of an aqueous solution containing 108 g of silver nitrate were added at a fixed flow rate. The pAg after the addition was found to be 8.0. After normal washing was performed, gelatin was added, and the pH and the pAg were adjusted to 5.8 and 8.8, respectively, at 40° C.

This emulsion was tabular silver iodobromide grains in which grains having an aspect ratio of 3 or more and an equivalent-circle diameter of 1.4 μm or more accounted for 80% of the projected area of all grains, and which had an average equivalent-circle diameter of 2.00 μm, a variation coefficient of an equivalent-circle diameter of 22%, an average thickness of 0.29 μm, an average aspect ratio of 7, and a total silver iodide content of 3.3 mol %.

Preparation of Emulsions 2-C to 2-E

Emulsions 2-C to 2-E shown in Table 1 were prepared following the same procedures as for the emulsion 2-B except that the ratio of the silver nitrate amount added in the step a to the silver nitrate amount added in the step c, the pAg value controlled in the step a, and the amount of the slightly soluble silver halide emulsion added in the step b were changed.

All of these emulsions were tabular silver iodobromide grains in which grains having an aspect ratio of 3 or more and an equivalent-circle diameter of 1.4 μm or more accounted for 80% of the projected area of all grains, and which had an average equivalent-circle diameter of 2.00 μm, a variation coefficient of an equivalent-circle diameter of 18%, an average thickness of 0.29 μm, and an average aspect ratio of 7.

The tabular silver halide emulsions (2-A) to (2-E) obtained by the above preparation methods were heated to 56° C., and dipotassium iridium hexachloride, sensitizing dyes (ExS-4), (ExS-7), and (ExS-8) to be presented later, sodium thiosulfate, chloroauric acid, potassium thiocyanate, and N,N′-dimethylselenourea were added to optimally perform chemical sensitization. “Optimally” herein mentioned indicates conditions under which 1/100-sec exposure sensitivity is highest.

The characteristics of the tabular emulsion grains (2-A) to (2-E) obtained as described above are shown in Table 1 above.

A sample 201 as a multilayered color sensitive material was manufactured by using the emulsions of the present invention explained in Example 2 in a sensitive material shown below. Samples 202 to 207 were manufactured by replacing the emulsion 2-A in the ninth layer with the emulsions 2-B to 2-E, respectively.

Multiple layers having the compositions presented below were coated on an undercoated cellulose triacetate film support to make the sample 201 as a multilayered color sensitive material.

Compositions of Sensitive Layers

The main materials used in the individual layers are classified as follows.

ExC: Cyan coupler

UV: Ultraviolet absorbent

ExM: Magenta coupler

HBS: High-boiling organic solvent

ExY: Yellow coupler

H: Gelatin hardener

ExS: Sensitizing dye

The number corresponding to each component indicates the coating amount in units of g/m². The coating amount of a silver halide is represented by the amount of silver. The coating amount of each sensitizing dye is represented in units of mols per mol of a silver halide in the same layer.

Sample 201

| 1st layer (Antihalation layer) | |
|---|---|
| Black colloidal silver silver | 0.18 |
| Gelatin | 1.40 |
| ExM-1 | 0.11 |
| ExF-1 | 3.4 × 10⁻³ |
| HBS-1 | 0.16 |
| 2nd layer (Interlayer) | |
| ExC-2 | 0.030 |
| UV-1 | 0.020 |
| UV-2 | 0.020 |
| UV-3 | 0.060 |
| HBS-1 | 0.05 |
| HBS-2 | 0.020 |
| Polyethylacrylate latex | 0.080 |
| Gelatin | 0.90 |
| 3rd layer (Low-speed red-sensitive emulsion layer) | |
| Emulsion A silver | 0.23 |
| Emulsion B silver | 0.23 |
| ExS-1 | 5.0 × 10⁻⁴ |
| ExS-2 | 1.8 × 10⁻⁵ |
| ExS-3 | 5.0 × 10⁻⁴ |
| ExC-1 | 0.050 |
| ExC-3 | 0.030 |
| ExC-4 | 0.14 |
| ExC-5 | 3.0 × 10⁻³ |
| ExC-7 | 1.0 × 10⁻³ |
| ExC-8 | 0.010 |
| Cpd-2 | 0.005 |
| HBS-1 | 0.10 |
| Gelatin | 0.90 |
| 4th layer (Medium-speed red-sensitive emulsion layer) | |
| Emulsion C silver | 0.70 |
| ExS-1 | 3.4 × 10⁻⁴ |
| ExS-2 | 1.2 × 10⁻⁵ |
| ExS-3 | 4.0 × 10⁻⁴ |
| ExC-1 | 0.15 |
| ExC-2 | 0.060 |
| ExC-4 | 0.050 |
| ExC-5 | 0.010 |
| ExC-8 | 0.010 |
| Cpd-2 | 0.023 |
| HBS-1 | 0.11 |
| Gelatin | 0. 60 |
| 5th layer (High-speed red-sensitive emulsion layer) | |
| Emulsion D silver | 1.62 |
| ExS-1 | 2.4 × 10⁻⁴ |
| ExS-2 | 1.0 × 10⁻⁵ |
| ExS-3 | 3.0 × 10⁻⁴ |
| ExC-1 | 0.10 |
| ExC-3 | 0.050 |
| ExC-5 | 2.0 × 10⁻³ |
| ExC-6 | 0.010 |
| ExC-8 | 0.010 |
| Cpd-2 | 0.025 |
| HBS-1 | 0.20 |
| HBS-2 | 0.10 |
| Gelatin | 1.30 |
| 6th layer (Interlayer) | |
| Cpd-1 | 0.090 |
| HBS-1 | 0.05 |
| Polyethylacrylate latex | 0.15 |
| Gelatin | 1.10 |
| 7th layer (Low-speed green-sensitive emulsion layer) | |
| Emulsion E silver | 0.24 |
| Emulsion F silver | 0.24 |
| ExS-4 | 4.0 × 10⁻⁵ |
| ExS-5 | 1.8 × 10⁻⁴ |
| ExS-6 | 6.5 × 10⁻⁴ |
| ExM-1 | 5.0 × 10⁻³ |
| ExM-2 | 0.28 |
| ExM-3 | 0.086 |
| ExM-4 | 0.030 |
| ExY-1 | 0.015 |
| HBS-1 | 0.30 |
| HBS-3 | 0.010 |
| Gelatin | 0.85 |
| 8th layer (Medium-speed green-sensitive emulsion layer) | |
| Emulsion G silver | 0.94 |
| ExS-4 | 2.0 × 10⁻⁵ |
| ExS-5 | 1.4 × 10⁻⁴ |
| ExS-6 | 5.4 × 10⁻⁴ |
| ExM-2 | 0.14 |
| ExM-3 | 0.045 |
| ExM-5 | 0.020 |
| ExY-1 | 7.0 × 10⁻³ |
| ExY-4 | 2.0 × 10⁻³ |
| ExY-5 | 0.020 |
| HBS-1 | 0.16 |
| HBS-3 | 8.0 × 10⁻³ |
| Gelatin | 0.80 |
| 9th layer (High-speed green-sensitive emulsion layer) | |
| Emulsion 2-A silver | 1.29 |
| ExS-4 | 3.7 × 10⁻⁵ |
| ExS-5 | 8.1 × 10⁻⁵ |
| ExS-6 | 3.2 × 10⁻⁴ |
| ExC-1 | 0.010 |
| Ex14-1 | 0.020 |
| ExM-4 | 0.050 |
| ExM-5 | 0.020 |
| ExY-4 | 5.0 × 10⁻³ |
| Cpd-3 | 0.050 |
| HBS-1 | 0.20 |
| HBS-2 | 0.08 |
| Polyethylacrylate latex | 0.26 |
| Gelatin | 1.45 |
| 10th layer (Yellow filter layer) | |
| Yellow colloidal silver silver | 7.5 × 10⁻³ |
| Cpd-1 | 0.13 |
| Cpd-4 | 7.5 × 10⁻³ |
| HBS-1 | 0.60 |
| Gelatin | 0.60 |
| 11th layer (Low-speed blue-sensitive emulsion layer) | |
| Emulsion I silver | 0.25 |
| Emulsion J silver | 0.25 |
| Emulsion K silver | 0.10 |
| ExS-7 | 8.0 × 10⁻⁴ |
| ExC-7 | 0.010 |
| ExY-1 | 5.0 × 10⁻³ |
| ExY-2 | 0.40 |
| ExY-3 | 0.45 |
| ExY-4 | 6.0 × 10⁻³ |
| ExY-6 | 0.10 |
| HBS-1 | 0.30 |
| Gelatin | 1.65 |
| 12th layer (Medium-speed blue-sensitive emulsion layer) | |
| Emulsion 3-A (prepared in Example 3 to be | 1.30 |
| described later) silver | |
| ExS-7 | 3.0 × 10⁻⁴ |
| ExY-2 | 0.15 |
| ExY-3 | 0.06 |
| ExY-4 | 5.0 × 10⁻³ |
| Cpd-2 | 0.10 |
| HBS-1 | 0.070 |
| Gelatin | 1.20 |
| 13th layer (1st protective layer) | |
| UV-2 | 0.10 |
| UV-3 | 0.12 |
| UV-4 | 0.30 |
| HBS-1 | 0.10 |
| Gelatin | 2.50 |
| 14th layer (2nd protective layer) | |
| Emulsion M silver | 0.10 |
| H-1 | 0.37 |
| B-1 (diameter 1.7 μm) | 5.0 × 10⁻² |
| B-2 (diameter 1.7 μm) | 0.15 |
| B-3 | 0.05 |
| S-1 | 0.20 |
| Gelatin | 0.70 |

In addition to the above components, to improve shelf stability, processability, pressure resistance, antiseptic and mildewproofing properties, antistatic properties, and coating properties, the individual layers contained W-1 to W-3, B-4 to B-6, F-1 to F-17, iron salt, lead salt, gold salt, platinum salt, iridium salt, palladium salt, and rhodium salt.

Cpd-4 was dispersed in the form of a solid in accordance with a method described in International Patent Application WO/88-4794.

Table 4 below shows the grain shapes and the like of the emulsions A to G and I and K used in the sample 201 described above.

TABLE 4

| | | | Inter-grain |
|---|---|---|---|
| | | | iodide |
| | | | distribution |
| | | | variation |
| | | Average AgI | coefficient |
| | Grain shape (halogen structure) | content (%) | (%) |
| Emulsion A | Circular tabular (uniform structure) | 0 | — |
| B | Cubic (double structure with high iodide | 1.0 | — |
| | shell) | | |
| C | Tetradecahedral (triple structure with high | 4.5 | 25 |
| | iodide intermediate shell) | | |
| D | Hexagonal tabular (structure with high | 2.0 | 16 |
| | iodide outside) | | |
| E | Circular tabular (structure with high iodide | 1.0 | — |
| | outside) | | |
| F | Octahedral (double structure with high | 6.0 | 22 |
| | iodide core) | | |
| G | Tetradecahedral (triple structure with high | 4.5 | 19 |
| | iodide intermediate shell) | | |
| I | Circular tabular (structure with high iodide | 2.0 | 15 |
| | central portion) | | |
| J | Cubic (uniform structure) | 1.0 | 10 |
| K | Tetradecahedral (double structure with high | 18.0 | 8 |
| | iodide core) | | |
| M | Non-light sensitive fine grain (uniform | 1.0 | — |
| | structure) | | |

TABLE 4

| | Average grain size, | Variation | |
|---|---|---|---|
| | equivalent-sphere | coefficient (%) | Diameter/thickness |
| | diameter (μm) | of grain size | ratio |
| Emulsion A | 0.45 | 15 | 5.5 |
| B | 0.20 | 8 | 1 |
| C | 0.85 | 18 | 1 |
| D | 1.10 | 17 | 7.5 |
| E | 0.45 | 15 | 3.0 |
| F | 0.25 | 8 | 1 |
| G | 0.85 | 19 | 1 |
| I | 0.45 | 15 | 6.0 |
| J | 0.30 | 8 | 1 |
| K | 0.80 | 18 | 1 |
| M | 0.04 | 15 | 1 |

In Table 4,

(1) The emulsions I to K were subjected to reduction sensitization during grain preparation by using thiourea dioxide and thiosulfonic acid in accordance with the embodiments in Jpn. Pat. Appln. KOKAI Publication No. 2-191938.

(2) The emulsions A to G and I to K were subjected to gold sensitization, sulfur sensitization, and selenium sensitization in the presence of the spectral sensitizing dyes described in the individual sensitive layers and sodium thiocyanate in accordance with the embodiments in Jpn. Pat. Appln. KOKAI Publication No. 3-237450.

(3) The preparation of tabular grains was performed by using low-molecular weight gelatin in accordance with the embodiments in Jpn. Pat. Appln. KOKAI Publication No. 1-158426.

(4) Dislocation lines as described in Jpn. Pat. Appln. KOKAI Publication No. 3-237450 were observed in tabular grains and regular crystal grains having a grain structure when a high-voltage electron microscope was used.

The couplers and additives in each layer were dispersed in a gelatin solution by a method shown in Table 5. The addition methods for individual layers are shown in Table 6.

TABLE 5

| Dispersion | |
|---|---|
| method | Method |
| A | Uniform aqueous solution of |
| | couplers, high-boiling point organic |
| | solvent(s), surfactant(s), NaOH, |
| | n-propanol, and other additive(s) is |
| | neutralized, precipitated, and |
| | dispersed |
| B | Uniform n-propanol solution of |
| | couplers, high-boiling point organic |
| | solvent(s), and other additive(s) is |
| | added to aqueous surfactant solution |
| | and precipitated and dispersed |
| C | Solution of couplers, high-boiling |
| | point organic solvent(s), |
| | surfactant(s), low-boiling point |
| | organic solvent(s), and other |
| | additive(s) and aqueous solution of |
| | gelatin and surfactants are mixed, |
| | stirred, and emulsified to disperse, |
| | and low-boiling point organic |
| | solvent(s) is removed by evaporation |
| D | Organic solvents are removed by |
| | washing or ultrafiltration after |
| | dispersion in method C |

TABLE 6

| | | Average |
|---|---|---|
| | Dispersion | dispersed grain |
| Layer | method | size [nm] |
| 3rd layer | C | 133 |
| 4th layer | C | 130 |
| 5th layer | D | 40 |
| 7th layer | C | 135 |
| 8th layer | C | 60 |
| 9th layer | A | 40 |
| 11th layer | C | 125 |
| 12th layer | B | 80 |

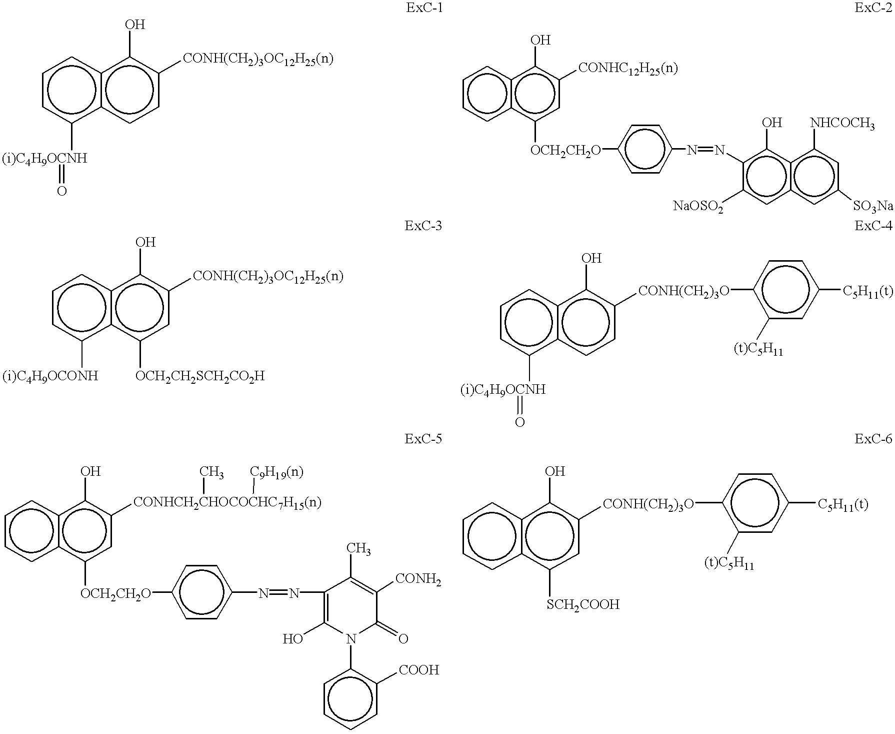

The sensitivity of the ninth layer was evaluated from an exposure amount by which a density higher by 0.1 than the lowest magenta density was given. The three different tests described earlier were conducted to evaluate the pressure resistance.

The results are shown in Table 7.

TABLE 7

| | | | Pressure | | Pressure | |
|---|---|---|---|---|---|---|
| | | | marks by | Pressure de- | marks in | |
| | | | thin nee- | sensitization | swelled | |
| | | | dle (fog | by thin nee- | state | |
| | | | after pres- | dle (density | (fog after | |
| | | | sure) - | after pres- | pressure) - | |
| Sam- | Emul- | Relative | (fog | sure) - (den- | (fog | |
| ple | sion | sensi- | before | sity before | before | Re- |
| No. | No. | tivity | pressure) | pressure) | pressure) | marks |
| 201 | 2-A | 25 | 0.20 | 0 | 0.02 | Com- |
| | | | | | | para- |
| | | | | | | tive |
| | | | | | | example |
| 202 | 2-B | 100 | 0.20 | −0.30 | 0.10 | Com- |
| | | (Stand- | | | | para- |
| | | ard) | | | | tive |
| | | | | | | example |
| 203 | 2-C | 112 | 0.40 | −0.05 | 0.20 | Com- |
| | | | | | | para- |
| | | | | | | tive |
| | | | | | | example |
| 204 | 2-D | 141 | 0.20 | −0.05 | 0.10 | Present |
| | | | | | | in- |
| | | | | | | vention |
| 205 | 2-E | 141 | 0.10 | −0.02 | 0.05 | Present |
| | | | | | | in- |
| | | | | | | vention |

As can be seen from Table 7, the samples 204 and 205 using the emulsions manufactured by the methods of the present invention could realize multilayered color sensitive materials having both high sensitivity and resistance to various external pressures.

### Example 3

Preparation of Emulsions 3-A to 3-D

Emulsions 3-A to 3-D shown in Table 1 presented earlier were prepared following the same procedures as for the emulsion 2-B except that the amount of the silver bromide tabular seed emulsion, the ratio of the silver nitrate amount added in the step a to the silver nitrate amount added in the step c, the pAg value controlled and the amount of potassium iodide added in the step a, and the amount of the slightly soluble silver halide emulsion added in the step b were changed in the emulsion preparation method of the emulsion 2-B in Example 2. In all of the emulsions 3-A to 3-D, grains having an aspect ratio of 3 or more and an equivalent-circle diameter of 1.4 μm or more accounted for 90% of the projected area of all grains.

The tabular silver halide emulsions (3-A) to (3-D) obtained by the above preparation methods were heated to 56° C., and a sensitizing dye (ExS-9) to be presented later, sodium thiosulfate, chloroauric acid, potassium thiocyanate, and N,N′-dimethylselenourea were added to optimally perform chemical sensitization. “Optimally” herein mentioned indicates conditions under which 1/100-sec exposure sensitivity is highest.

A sample 301 as a multilayered color sensitive material was formed by using the emulsions manufactured by the methods of the present invention explained in Example 3 in the sensitive material presented as the sample 201 in Example 2. Samples 302 to 304 were formed by replacing the emulsion 3-A in the 12th layer with the emulsions 3-B to 3-D, respectively.

The sensitivity of the 12th layer was evaluated from an exposure amount by which a density higher by 0.1 than the lowest yellow density was given. The three different tests described earlier were conducted to evaluate the pressure resistance. The results are shown in Table 8.

TABLE 8

| | | | Pressure | | Pressure | |
|---|---|---|---|---|---|---|
| | | | marks by | Pressure de- | marks in | |
| | | | thin nee- | sensitization | swelled | |
| | | | dle (fog | by thin nee- | state | |
| | | | after pres- | dle (density | (fog after | |
| | | | sure) - | after pres- | pressure) - | |
| Sam- | Emul- | Relative | (fog | sure) - (den- | (fog | |
| ple | sion | sensi- | before | sity before | before | Re- |
| No. | No. | tivity | pressure) | pressure) | pressure) | marks |
| 301 | 3-A | 100 | 0.50 | +0.10 | 0.30 | Com- |
| | | (Stand- | | | | para- |
| | | ard) | | | | tive |
| | | | | | | example |
| 302 | 3-B | 126 | 0.40 | −0.35 | 0.30 | Com- |
| | | | | | | para- |
| | | | | | | tive |
| | | | | | | example |
| 303 | 3-C | 158 | 0.20 | −0.10 | 0.15 | Present |
| | | | | | | in- |
| | | | | | | vention |
| 304 | 3-D | 158 | 0.25 | −0.05 | 0.10 | Present |
| | | | | | | in- |
| | | | | | | vention |

As can be seen from Table 8, the samples 303 and 304 using the emulsions manufactured by the methods of the present invention could realize multilayered color sensitive materials having both high sensitivity and resistance to various external pressures.

### Example 4

Samples 401 to 405 were formed following the same procedures as for the samples 201 to 205 except that the support used in the sample 104 of Example 1 in U.S. Pat. No. 597,682, i.e., the PEN support on which an underlayer and a back layer were formed and which was heat-treated by the methods described in the same specification, column 21, line 54 to column 23, line 29 was used instead of the cellulose triacetate film support in the samples 201 to 205 of Example 2.

The samples 404 and 405 of the present invention were different from the samples 204 and 205 in Example 2 only in the support but could realize multilayered color sensitive materials having both high sensitivity and resistance to various external pressures.

### Example 5

Samples 501 to 505 were formed following the same procedures as for the samples 201 to 213 except that each sample was processed into a 120 size in accordance with ISO732:1991(E), a light-shielding sheet was formed, and the resultant sample was wound into a spool formed in accordance with ISO732:1991(E) in the samples 201 to 205 of Example 2.

The samples 504 and 505 of the present invention could realize multilayered color sensitive materials having both high sensitivity and resistance to various external pressures.

Additional advantages and modifications will readily occurs to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A method of manufacturing a silver halide photographic emulsion, comprising
a process of forming silver halide tabular grains in which 50% or more of a projected area of the total silver halide being accounted for by tabular grains having an aspect ratio of 3 or more and a equivalent-circle diameter of 1.4 μm or more;
said process comprising a host tabular grain formation step (step a), a step of adding an emulsion which contains slightly soluble silver halide grains (step b), and an outermost shell formation step (step c);
a silver amount (C_{Ag}) consumed in the (step a) and a silver amount (S_{Ag}) consumed in the (step b) and the (step c) being defined by equation (I) below
S_{Ag}/C_{Ag}=[R³/(R−d)³]−1 (I)
where d satisfies 0<d≦0.15 and R represents the equivalent-sphere diameter of a final grain.

2. The method according to claim 1, wherein d in equation (I) is 0<d≦0.10.

3. The method according to claim 2, wherein 50% or more of the projected area of said total silver halide are accounted for by tabular grains having an aspect ratio of 7 or more.

4. The method according to claim 2, wherein the equivalent-circle diameter of said silver halide tabular grains is 2.0 to 5.0 μm.

5. The method according to claim 2, wherein the variation coefficient of the equivalent-circle diameter of said silver halide tabular grains is 20% or less.

6. The method according to claim 1, wherein a surface silver iodide content of said silver halide grains is not more than 5 mol %.

7. The method according to claim 2, wherein a surface silver iodide content of said silver halide grains is not more than 5 mol %.

8. The method according to claim 7, wherein 50% or more of the projected area of said total silver halide are accounted for by tabular grains having an aspect ratio of 7 or more.

9. The method according to claim 7, wherein the equivalent-circle diameter of said silver halide tabular grains is 2.0 to 5.0 μm.

10. The method according to claim 7, wherein the variation coefficient of the equivalent-circle diameter of said silver halide tabular grains is 20% or less.

11. The method according to claims 1, wherein said silver halide grains have not less than 10 dislocation lines per grain.

12. The method according to claim 11, wherein 50% or more of the projected area of said total silver halide are accounted for by tabular grains having an aspect ratio of 7 or more.

13. The method according to claim 11, wherein the equivalent-circle diameter of said silver halide tabular grains is 2.0 to 5.0 μm.

14. The method according to claim 11, wherein the variation coefficient of the equivalent-circle diameter of said silver halide tabular grains is 20% or less.

15. A silver halide emulsion manufactured by a method according to one of claim 1.

16. The silver halide emulsion manufactured by a method according to one of claim 7.

17. The silver halide emulsion manufactured by a method according to one of claim 11.

18. A silver halide photosensitive material comprising, on a support, a silver halide photographic emulsion layer containing a silver halide emulsion manufactured by a method according to any one of claim 1.

19. A silver halide photosensitive material comprising, on a support, a silver halide photographic emulsion layer containing a silver halide emulsion manufactured by a method according to any one of claim 7.

20. A silver halide photosensitive material comprising, on a support, a silver halide photographic emulsion layer containing a silver halide emulsion manufactured by a method according to any one of claim 11.
